(19) United States
(12) Patent Application Publication
(10) Pub. No.: US 2026/0054834 A1
(43) Pub. Date: Feb. 26, 2026

(54) SYSTEM AND METHOD FOR ARMING AN EXPLOSIVE DEVICE CONFIGURED FOR AN AIRCRAFT

(71) Applicant: Fortem Technologies, Inc., Pleasant Grove, UT (US)

(72) Inventors: Jake GOSLING, Eagle Mountain, UT (US); Adam ROBERTSON, Provo, UT (US); Jeff DAVIS, Lehi, UT (US); Devin LEBARON, Saratoga Springs, UT (US); James BRIDGE, Provo, UT (US); Jacob OLSON, Orem, UT (US); Kendall FOWKES, Provo, UT (US); Palmer CLEGG, Saratoga Springs, UT (US); Scott OEHLER, Riverton, UT (US); Spencer PROWS, Pleasant Grove, UT (US); Jeremy SOMMER, Lake Park, MN (US); Magnus WALLMARK, Austin, TX (US); Mark ARGYLE, Lindon, UT (US)

(21) Appl. No.: 18/811,869

(22) Filed: Aug. 22, 2024

(51) Int. Cl. B64D 1/06; B64U 101/18; F42C 15/42

(52) U.S. Cl. CPC B64D 1/06; F42C 15/42; B64U 2101/18

(57) ABSTRACT

A system and method are provided for safe arming a flying machine that carries an explosive device. Once armed, the flying machine can provide air defense against a target (e.g., an unwanted aircraft) by using the explosive device to kinetically intercept the unwanted aircraft. The flying machine can include an explosive device, an arming device, and one or more sensors (e.g., a 9-axis inertial measurement unit). By processing the sensor data, the flying machine determines whether arming criteria have been satisfied (e.g., the flying machine has attained a desired altitude or undergone a specified pattern of accelerations), and when the arming criteria are satisfied the flying machine arms the explosive device by completing a detonation path. If the explosive device is not detonated, the system returns to a safe state before the flying machine back to its origin.

### RELATED APPLICATION

The present disclosure relates to application Ser. No. 18/808,333 (Docket No. 092146-774226), filed on Aug. 19, 2024 and which is incorporated herein by reference.

### TECHNICAL FIELD

The present disclosure relates to a new system and method for safe arming ordnance and/or explosives in flying machines, and, more particularly, the present disclosure relates to a new system and method for safe arming a kinetic projectile device mounted on a flying machine such as a drone or quadcopter to kinetically intercept and disable another aircraft (e.g., a drone) that presents a threat in a given airspace.

### BACKGROUND

Safe arming devices for ordnance used in artillery can use a combination of gears, springs, and other mechanical components to prevent arming of the explosive in the ordnance until after the ordnance has undergone a series of forces. For example, upon being shot from an artillery barrel, the ordnance experiences a large, sudden acceleration, and rifling along the bore of the barrel induces the ordnance to spin, resulting in centrifugal forces. These forces can cause various masses attached to springs to compress (or extend) the springs to a specified length at which they are locked in place, thereby enabling a detonation path to be completed.

Generally, safety and arming devices keep the ordnance section of a munition from arming during shipping, handling, and storage. The device also arms the ordnance section at the proper time by sensing that a predetermined set of conditions has been met. The safety and arming device can allow/cause the high explosives to initiate when the munition senses that it has either hit or is in a close proximity to the target.

Because explosives are inherently hazardous, the safety and arming device plays an important role in mitigating (to an acceptable level) the hazards associated with the initiation of the explosives. This objective is accomplished by isolating the initiating stimuli from the insensitive secondary explosives during times when equipment or people are within the hazard area. The initiating stimuli can be heat, shock, light, static electricity, or any other mechanism that transfers enough energy to initiate the explosives. For example, safety and arming device can include a mechanical barrier that insulates the explosive from shock waves while the safety and arming devices is in a safe state/condition.

Although safe arming devices for ordnance fired from artillery are known, safe arming devices for explosives and ordnance in drones is unknown. For example, defensive drones can carry explosives/ordnance to defend against threats due to unwanted aircraft that are intruding in a restricted space. The unwanted aircraft may be an un-manned drone that is armed with a warhead to be detonated at a given target site. Similar to naval mines or land mines, these defensive drones provide deterrence and prevent enemies from entering and detonating explosives in a protected region. Unlike naval mines or land mines, defensive drones have limited flight time during which they can be positioned in their defensive positions. While armed, the defensive drone presents a hazard to people working with or in proximity to the drones.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates a diagram of an example of a flying machine for defending against a target aircraft, in accordance with some example implementations.

FIG. 1B illustrates a diagram of the flying machine determining an intercept point along a path of the target aircraft, in accordance with example implementations.

FIG. 1C illustrates a diagram of the flying machine intercepting the target aircraft, in accordance with some example implementations.

FIG. 1D illustrates a diagram of an example of an intercept aircraft, in accordance with some example implementations.

FIG. 1E illustrates a diagram of an intercept aircraft, in accordance with some example implementations.

FIG. 1F illustrates a view of a warhead and initiator insertion, in accordance with some example implementations.

FIG. 1G illustrates how a warhead can be slid into or inserted into the intercept aircraft, in accordance with some example implementations.

FIG. 2 illustrates a diagram of the flying machine taking various actions to arm an explosive device, in accordance with some example implementations.

FIG. 3A illustrates a diagram of an example of an arming device in a detonation signal path to an explosive device, in accordance with some example implementations.

FIG. 3B illustrates a diagram of an example firing sequence for an explosive device, in accordance with some example implementations.

FIG. 3C illustrates a diagram of an example of a firing circuit design and for an explosive device, in accordance with some example implementations.

FIG. 3D illustrates a weighted base configured with an intercept aircraft, in accordance with some example implementations.

FIG. 3E illustrates another view of the weighted base configured with the intercept aircraft, in accordance with some example implementations.

FIG. 3F illustrates another view of the tether, cable or safety pull cord attached to the weighted base and configured with the intercept aircraft, in accordance with some example implementations.

FIG. 3G illustrates a view of a tether or safety pull cord attached to the weighted base and configured with the intercept aircraft, in accordance with some example implementations.

FIG. 4A illustrates a flow diagram of a method for defending against the target aircraft, in accordance with some example implementations.

FIG. 4B illustrates another flow diagram of a method for defending against the target aircraft, in accordance with some example implementations.

FIG. 4C illustrates a state overview for safety procedures for the intercept aircraft, in accordance with some example implementations.

FIG. 4D illustrates a method related to using blast characteristics to determine a flight plan for an intercept aircraft, in accordance with some example implementations.

FIG. 5A illustrates an initial setup for a ground-launched air-to-air munition, in accordance with some example implementations.

FIG. 5B illustrates a launch and eventual detonation series for the ground-launched air-to-air munition, in accordance with some example implementations.

FIG. 6 illustrates a block diagram of an example of a computing device, in accordance with some example implementations.

### DESCRIPTION OF EXAMPLES

### Brief Introduction

Disclosed are a system and method associated with safe arming a flying machine (e.g., a drone or a quadcopter). For example, once armed, the flying machine can provide air defense against unwanted aircraft in a given air space by performing a kinetic interception of the unwanted aircraft. The system and method relate to adjusting between a safe state and an armed state for the flying machine with an explosive package configured thereon.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some aspects, the techniques described herein relate to a flying machine including: an explosive device fixed to the body of the flying machine; an arming device configured to interrupt a detonation path when in a safe state and to complete the detonation path when in an armed state; one or more sensors configured to measure an acceleration, a position, and/or an environmental condition of the flying machine and to generate sensor data therefrom; one or more processors; and a memory storing instructions that, when executed by the one or more processors, configure the flying machine to: determine, based on the sensor data, whether two or more arming criteria are satisfied, and signal, when the two or more arming criteria are satisfied, the arming device to transition from the safe state to the armed state.

In some aspects, the techniques described herein relate to a method of arming an explosive device of an aircraft, the method including: generating sensor data using one or more sensors configured to measure an acceleration, a position, and/or an environmental condition of a flying machine; processing, by one or more processors, the sensor data to determine whether two or more arming criteria are satisfied; signaling, to an arming device, an instruction to transition from a safe state to an armed state when the two or more arming criteria are determined to be satisfied; and transitioning from the safe state to the armed state by completing a detonation path through the arming device to thereby allow a detonation signal to pass through the arming device towards the explosive device of the flying machine.

In some aspects, the techniques described herein relate to an explosive device that is configured to attach to a flying machine, the explosive device including: an explosive; a detonation device configured to detonate the explosive; a detonation signal system between the detonation device and a detonation source, the detonation signal system including a detonation signal path and an arming device, wherein the detonation signal path is configured to conduct a detonation signal from the detonation source to the detonation device, and the arming device is configured to prevent detonating an explosive when in a safe state and allow detonating the explosive when in an armed state; one or more processors; and a memory storing instructions that, when executed by the one or more processors, configure the explosive device to: determine, based on sensor data of an inertial measurement unit (IMU), whether two or more arming criteria are satisfied, and signal the arming device to transition from the safe state to the armed state when the two or more arming criteria are satisfied.

In some aspects, a computer-readable storage media is disclosed which stores instructions. When the instructions are executed by one or more processors, the instructions cause the one or more processors to be configured to: determine, based on sensor data of an inertial measurement unit (IMU), whether two or more arming criteria are satisfied for an explosive device, the explosive device comprising: an explosive; a detonation device configured to detonate the explosive; a detonation signal system between the detonation device and a detonation source, the detonation signal system comprising a detonation signal path and an arming device, wherein the detonation signal path is configured to conduct a detonation signal from the detonation source to the detonation device, and the arming device is configured to prevent detonating an explosive when in a safe state and allow detonating the explosive when in an armed state; and signal the arming device to transition from the safe state to the armed state when the two or more arming criteria are satisfied.

In some aspects, a computer-readable storage media is disclosed which stores instructions. When the instructions are executed by one or more processors configured on a flying machine comprising an explosive device fixed to a body of the flying machine; an arming device configured to prevent detonating an explosive when in a safe state and allow detonating the explosive when in an armed state; one or more sensors configured to measure an acceleration, a position, and/or an environmental condition of the flying machine and to generate sensor data therefrom, the instructions cause the one or more processors to be configured to: determine, based on the sensor data, whether two or more arming criteria are satisfied, and signal the arming device to transition from the safe state to the armed state when the two or more arming criteria are satisfied.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### Example Implementations

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for air defense systems for disabling intrusive aircraft via kinetic interception. For example, an unwanted aircraft may enter restricted airspace or may present a security risk. Although other solutions (e.g., conventional air defense systems or net-based air defense systems) could disable the unwanted aircraft to mitigate security risks, these other solutions might not be the best solution for certain aircraft. For example, conventional air defense systems might be overkill, costing significantly more than the unwanted aircraft, and therefore they would be too expensive. Additionally, net-based air defense systems might be ineffective for disabling the unwanted aircraft, resulting in an unreasonably high percentage of unwanted aircraft breaching the air defense.

According to certain non-limiting examples, the solution described herein is kinetic-interception air defense that predicts the path of an unwanted aircraft, flies an intercept aircraft to an intercept point along the predicted path, where the intercept aircraft waits for the unwanted aircraft, and detonates a kinetic projectile device upon the unwanted aircraft's arrival at the intercept point. The intercept aircraft can deter and mitigate unwanted intruders by detonating an explosive with the intruder is nearby. Further, ball bearings, pellets, or other components can be packed near to explosive to provide shrapnel that is directed a predefined solid angle to shred or hit critical parts of the unwanted aircraft thereby disabling the unwanted aircraft by rendering one or more critical parts unsuitable for flight. For example, the shrapnel can hit electronics components, controllers, processors, sensors, motors, wings, steering components, or any other parts that are required separately or in combination to provide flight capabilities.

According to certain non-limiting examples, the intercept aircraft flies to and then hovers below the intercept point to wait for the target aircraft. A kinetic interception in which the intercept aircraft detonates an explosion below the target aircraft has the benefit that aircraft are generally not designed to resist stress on the wings due to an upward force on the fuselage. That is, in flight, the upward lift forces on the wings are transferred to the fuselage. Consequently, the connection between the wings and the fuselage is reinforced to withstand more upward force on the wings than on the fuselage, but the connection is not reinforced for a much greater upward force on the fuselage than on the wings. Thus, an explosion below the aircraft, as opposed to above, can be more effective at damaging the connection between the wings and the fuselage, thereby disabling the target aircraft.

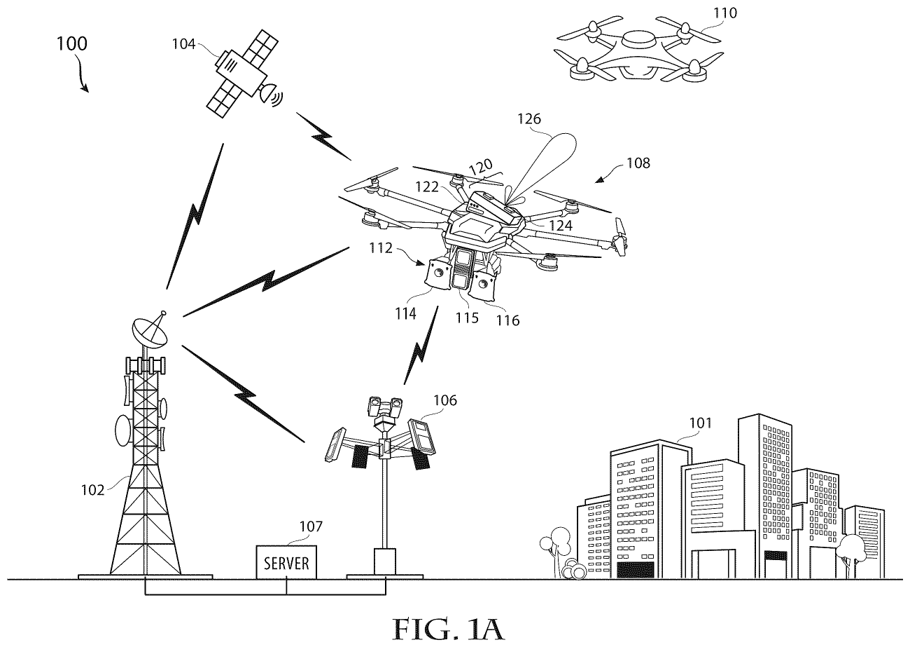

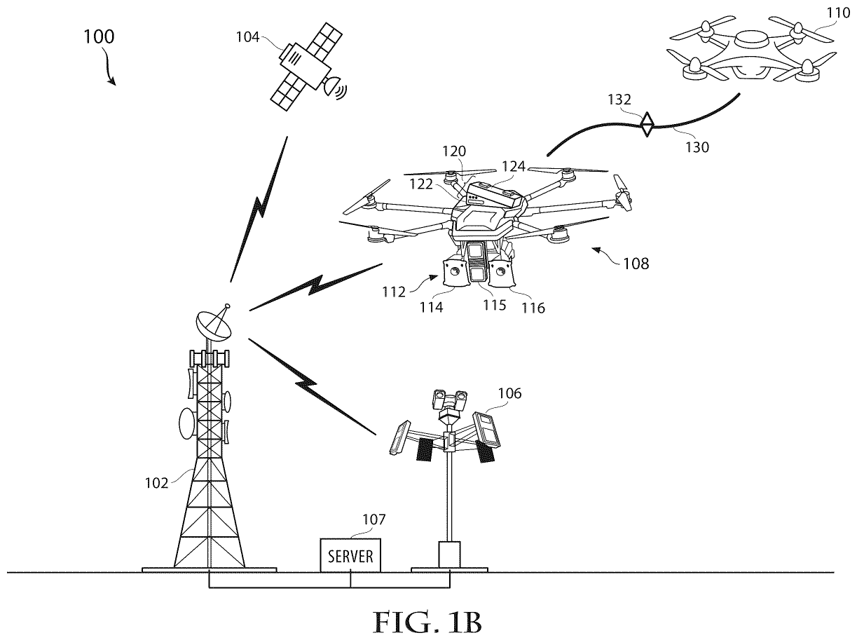

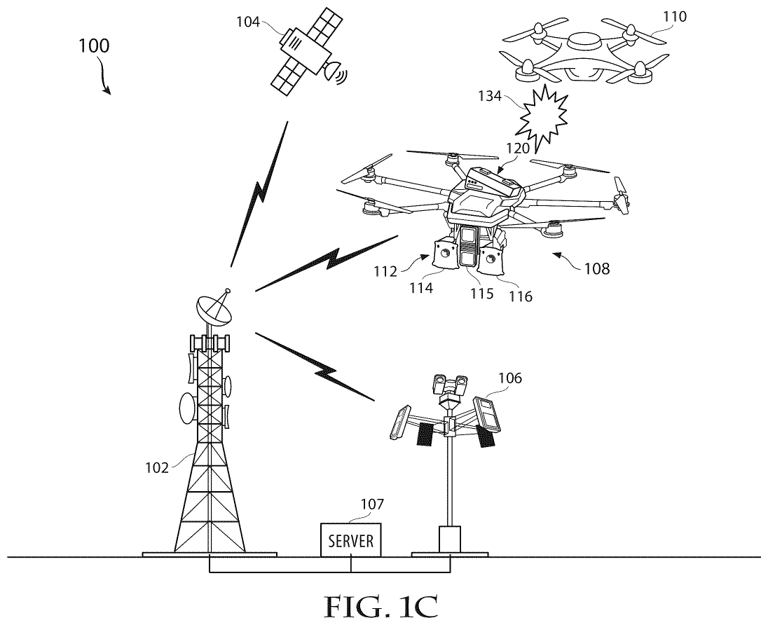

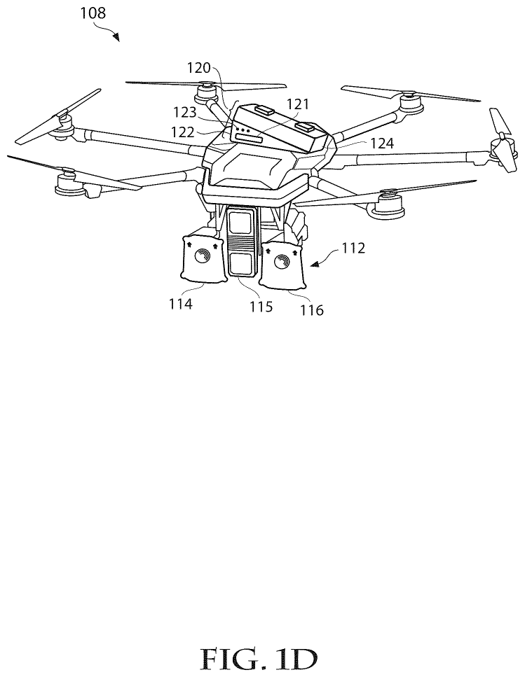

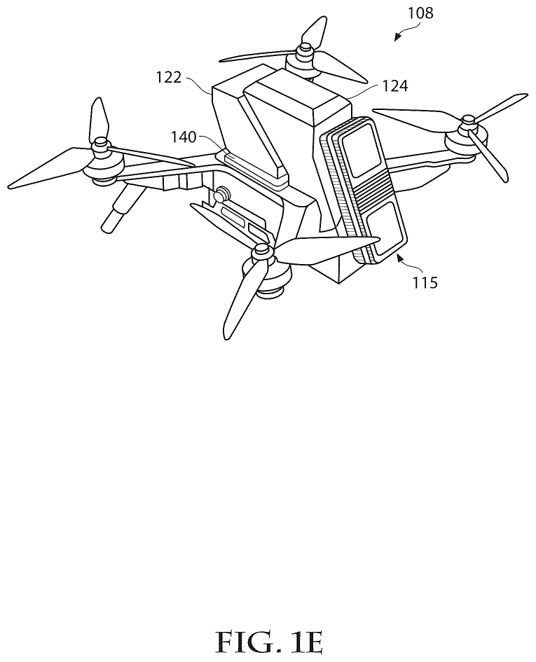

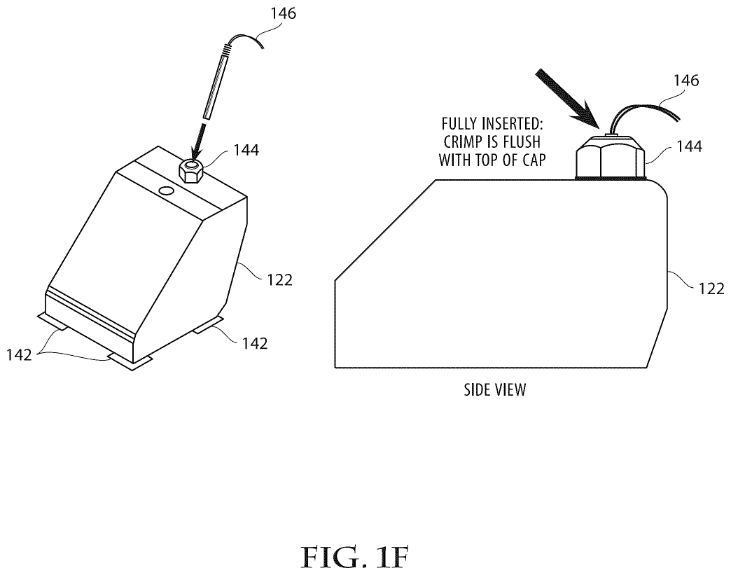

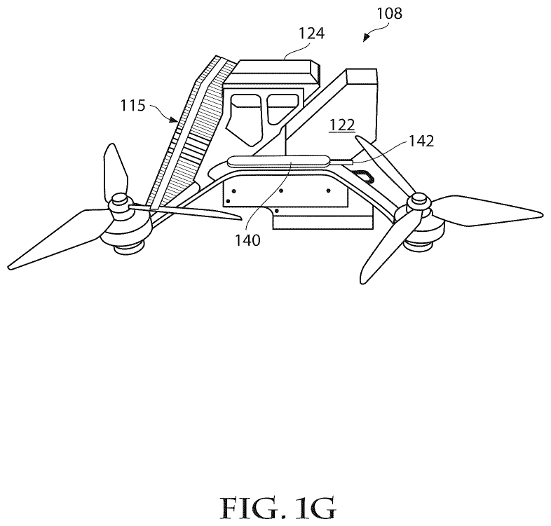

FIG. 1A illustrates an aircraft environment 100 for detecting and mitigating a target aircraft 110 (e.g., a drone that is trespassing into restricted airspace). The aircraft environment 100 can include one or more communication towers 102, one or more satellites 104, one or more ground-based radar and camera system 106, an intercept aircraft 108 and a target aircraft 110. The aircraft environment 100 can include buildings such as would exist in a city 101. The one or more ground-based radar and camera system 106 can include a radar and/or a camera system that can provide one or more of radar data and visual data for validation of the target aircraft 110 and optical classification. The one or more satellites 104, the one or more ground-based radar and camera system 106, and the intercept aircraft 108 can be configured with radar systems that perform various functions for detection, ranging, and tracking the location of the target aircraft 110. Furthermore, the one or more communication towers 102, the one or more satellites 104, the one or more ground-based radar and camera system 106 and the intercept aircraft 108 can include communication components that enable each respective device to communicate with other devices in the aircraft environment 100. In this manner, the intercept aircraft 108 can obtain information about the position, classification, and/or movement of the target aircraft 110 from one or more sources of data and move into the proper position for implementing a kinetic intercept as disclosed herein.

In some aspects, a radar and projectile system 112 of the intercept aircraft 108 can have a first projectile package 114, a set of antenna arrays 115 and a second projectile package 116. As shown, the radar system is configured on a side of the intercept aircraft 108. The radar and projectile system 112 is optional on the intercept aircraft 108 in that there is also another radar system disclosed which is the focus of this application. The different radar systems disclosed herein may be the same or different. For example, the set of antenna arrays 115 may represent an older technology that competitors or bad actors may already be aware of. A new more proprietary technology may be deployed in the radar system disclosed below which would be destroyed as part of kinetic intercept operation.

The ground-based radar and camera system 106 can include radio communication or wireless communication components that enable wireless communication with the intercept aircraft 108. In this manner, a server 107 can be in communication with the intercept aircraft 108 and can receive data and provide instructions, such as abort commands or fire commands, based on data received. The server 107 can enable operators to track the progress of the intercept aircraft 108 through various stages of arming as disclosed herein and can enable, where an automated approach is not desirable or configured, to have a human or algorithm or program on the server 107 to make abort or detonation decisions.

For example, if the intercept aircraft 108 is approaching an intercept position, a user can still abort the mission such as by causing the intercept aircraft 108 to elevate to a high elevation and simply blow up.

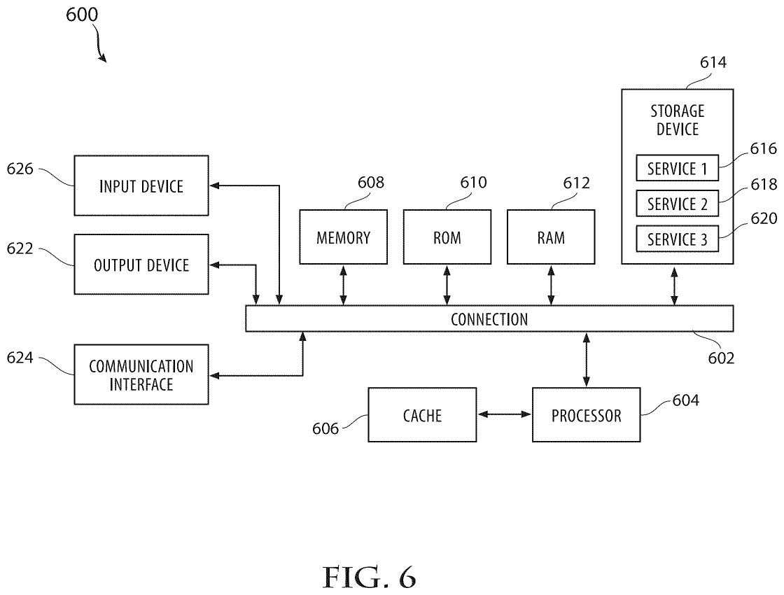

A control system (not shown but can include any one or more of components of the computing system 600 of FIG. 6) can be configured on the intercept aircraft 108 that can control the operations of the various systems and coordinate deployment of one or more of a projectile from the first projectile package 114 or the second projectile package 116 as well as a radar/kinetic projectile package 120. For example, the control system may cause the intercept aircraft to deploy a first net from the first projectile package 114 and then position itself near the target aircraft 110 (whether or not it has been captured in the first net) and deploy the kinetic intercept from the radar/kinetic projectile package 120. Thus, the operations of the various systems may be combined in a sequence depending on one or more parameters.

The radar/kinetic projectile package 120 can be configured, in one example, on a top surface of a fuselage of the intercept aircraft 108. The radar/kinetic projectile package 120 can include a kinetic projectile component 122, (the kinetic projectile component 122 can include an explosive or explosives 121 and projectiles 123) and a radar antenna 124 configured together, adjacent to each other or in some other manner configured to enable projectiles in the kinetic projectile package 120 to interact with the radar antenna 124 upon deployment. The radar/kinetic projectile package 120 can include an attachment member (not shown) configured to attach the radar/kinetic projectile package 120 to the fuselage of intercept aircraft 108. The attaching member may be screws, an adhesive, a track such that the radar/kinetic projectile package 120 slides and locks into place, or any other type of attachment member. Note as well that the radar/kinetic projectile package 120 may be removable or replaceable with a different radar/kinetic projectile package 120 depending on the task at hand. Thus, the attachment member can enable the radar/kinetic projectile package 120 to be removed and replaced from the intercept aircraft 108. Further, the intercept aircraft 108 may include multiple similar or different versions of the radar/kinetic projectile package 120 and the control system may determine to select on of a plurality of explosive systems. In one aspect, there may be different types of explosive or explosives 121 and different types of projectiles 123 that are configured under the radar antenna 124 and depending on data such as a characteristic of the target aircraft 110, the control system may select a first type or second type of explosive or explosives 121 or type of projectiles 123 for deployment.

A directional antenna gain 126 is shown for the radar antenna 124 that directs a significant portion of the radiated electromagnetic energy in a relatively small solid angle (e.g., but not limited to, a solid angle less than 1 steradian, a solid angle less than 0.5 steradians, a solid angle less than 0.25 steradians, or a solid angle less than 0.1 steradians).

As noted above, an aspect of this disclosure relates to deploying a kinetic intercept to take down the target aircraft 110. In some aspects, the kinetic intercept can include the purposeful destruction of a component or system on the intercept aircraft 108. For example, the radar antenna 124 or components of the radar/kinetic projectile package 120 may be desirable to destroy as part of the kinetic intercept. The purpose of destroying part of the radar/kinetic projectile package 120 may be to protect the knowledge of the structure of the radar antenna 124 from falling into the wrong hands.

The radar antenna 124 in the radar/kinetic projectile package 120 can be arranged such that the main lobe of the radar signal or the directional antenna gain 126 is pointed along a direction of travel when the intercept aircraft 108 is operating near its maximum velocity. For example, to reach its maximum horizontal velocity, the intercept aircraft 108 can be oriented at a pitch angle of 65°. In this case, the radar of the intercept aircraft 108 would be oriented substantially close to 65° from a horizontal axis of the intercept aircraft 108 (e.g., but not limited, 65°±20°). This accounts for the intercept aircraft 108 being oriented near the pitch angle of approximately 65° when the intercept aircraft 108 is seeking for a target aircraft 110 along the horizon. Such an arrangement enables the intercept aircraft 108 to travel at near optimal speeds while also being able to detect and track the target aircraft 110 at long distances.

According to certain non-limiting examples, the system of the radar/kinetic projectile package 120 together with the intercept aircraft 108 can be arranged and oriented such that the radar antenna 124 and the kinetic projectile component 122 (e.g., which can be a combination of an explosives 121 together with the kinetic projectiles such as projectiles 123) respectively have fixed orientations relative to the body of the intercept aircraft 108. The fixed orientation is selected such that the projectiles are launched in a direction such that the radar/kinetic projectile package 120 is orientated to launch the projectiles in a direction is substantially aligned with the directional antenna gain 126. For example, the radar antenna 124 can be orientated to have an antenna gain that is substantially maximum in a given direction, and the given direction is substantially along the travel direction of the intercept aircraft 108 when it is traveling at a maximum speed.

As used herein, the directional antenna gain 126 that is substantially maximum means that the antenna gain is within 20% of the maximum antenna gain (e.g., the antenna gain is 80% or greater of the maximum antenna gain). As used herein, a direction that is substantially along a travel direction means the direction deviates by less 20° from the travel direction.

According to certain non-limiting examples, the radar antenna 124 in the radar/kinetic projectile package 120 can be a phased array antenna that provides a degree of beam steering, but the greatest antenna gain can be obtained for steering angles near normal incidence to the antenna array.

According to certain non-limiting examples, one or more of the radar and projectile system 112 and radar antenna 124 on the intercept aircraft 108 can obtain angle, range, and velocity measurements for the target aircraft 110, which can then be used to predict the path/trajectory to be traversed by the target aircraft 110. Using the predicted path, the intercept aircraft 108 can select an intercept point along the path, fly to and then hover at a point just below the intercept point, where the intercept aircraft 108 waits to detonate a kinetic projectile (such as projectiles 123) in the kinetic projectile component 122 to disable the target aircraft 110 as well as destroy or disable the radar antenna 124.

FIG. 1A also shows a first projectile package 114 and a second projectile package 116 which can each contain a respective projectile such as a net or other projective for capturing the target aircraft 110. The control system would be used to deploy projectiles from the first projectile package 114 or the second projectile package 116 independently or in connection with an overall strategy (that can including using the projectiles 123) to take down or destroy the target aircraft 110.

FIG. 1B illustrates the intercept aircraft 108 flying along a predicted path 130 of the target aircraft 110 to an intercept point 132. The intercept aircraft 108 then hovers while waiting for the predicted instance (i.e., when the intercept aircraft 108 is a certain distance from the target aircraft 110) to detonate the kinetic projectile component 122 to deploy the projectiles 123 towards the target aircraft 110.

FIG. 1C illustrates the intercept aircraft 108 performing the kinetic interception 134 of the target aircraft 110, e.g., by detonating the explosives 121 in the kinetic projectile component 122. The kinetic projectile component 122 is arranged as a directed charge to launch the projectiles 123 toward the intercept point 132 and for a kinetic interception 134 with the target aircraft 110.

According to certain non-limiting examples, the kinetic interception 134 can disable both the intercept aircraft 108 and the target aircraft 110. Whereas some smaller or slower aircraft such as quadcopters can be captured and disabled using nets, nets (which might be deployed from the first projectile package 114 or the second projectile package 116) might not work to disable larger and/or faster aircraft such as target aircraft 110. The kinetic interception 134 can, however, disable larger and/or faster aircraft than net-based interception techniques. The explosive charge used for kinetic interception 134 can result in the intercept aircraft 108 being a single-use device for performing the kinetic interception 134. For example, an explosion originating from the intercept aircraft 108 that is large enough to disable the target aircraft 110 is also likely to cause significant damage to the intercept aircraft 108 itself.

As noted above as well, in some cases, the target aircraft 110 may be able to be disabled by a combination of deploying a net (or some other projectile) first and then performing the kinetic interception 134. The strategy may also be the opposite in that the control system may deploy the kinetic interception first, and then seek to capture the target aircraft 110 (if possible) with a net from the first projectile package 114 or the second projectile package 116.

FIG. 1D shows the intercept aircraft 108 can include both a flying device (e.g., a quadcopter) and a radar/kinetic projectile package 120. The intercept aircraft 108 includes a flying device, a radar/kinetic projectile package 120 and other components used for tracking altitude, acceleration or other factors associated with movement of the intercept aircraft 108. As noted above, a control system also can be included which controls the movement of the intercept aircraft 108 and the various on-board systems that can cause the kinetic interception 134 and/or other types of intercept.

FIG. 1E illustrates a variation of an intercept aircraft 108. The intercept aircraft 108 in this figure has a different position or location of the set of antenna arrays 115, the radar antenna 124 and the kinetic projectile component 122. The kinetic projectile component 122 can also be called a ground-launched air-to-air munition. A track 140 is also shown which can be used to attach the kinetic projectile component 122. The kinetic projectile component 122 can be snapped into place. In this configuration, the kinetic projectile component 122, when detonated, will at least partially destroy the set of antenna arrays 115 and the radar antenna 124 given the positioning of the set of antenna arrays 115 higher up on the intercept aircraft 108 and thus in the blast path of the kinetic projectile component 122.

FIG. 1F illustrates a view of a warhead and initiator insertion for the kinetic projectile component 122. A filler cap 144 which can include an initiator is shown with wiring 146 that can be used to electrically connect (i.e., provide power to) the kinetic projectile component 122 to the intercept aircraft 108 and its control systems. The initiator can be a detonator for the munition or main charge in the warhead. Any type of detonator can be used as well as any type of main charge. For example, the main charge can be an all-liquid binary explosive with diethylenetriamine (DETA) and nitromethane. In some cases, other components such as ball bearings can be included in the kinetic projectile component 122 as well as the all-liquid binary explosive. There can be different configurations of the kinetic projectile component 122. The blast characteristics can be communicated manually, from a remote server, or via a memory or microcontroller configured on the kinetic projectile component 122 to the intercept aircraft 108 for making adjustments to a flying plan or how to position the intercept aircraft 108 relative to the target aircraft 110. The blast characteristics or fragmentation patterns can be used for making timing decisions or choosing arming criteria for safe detonation of the explosive. For example, the explosive C4 may have different fragmentation patterns than using an all-liquid binary explosive. The size and number of ball bearings and other factors may impact the different blast characteristics, which data can be used to make changes to one or more feature of the entire process of starting in a safe state, and transitioning to an armed state and ultimate detonation of the explosive to take out the target aircraft 110.

In one example, a safe-armed device on the intercept aircraft 108 may require the intercept aircraft 108 to make specific movements like two flips in the air or any other particular movement before detonating the explosive. The intercept aircraft 108 here can be characterized as a “multi-copter” meaning it had multiple downward-thrusting motor/propeller units. The specific movements that might be required before arming the explosive can apply to movements characteristic of or capable of being performed by the intercept aircraft 108 as a multi-copter.

Attachment members 142 are shown as well which can have a complementary structure or configuration with respect to the track 140 to enable the kinetic projectile component 122 to be slid into place or locked into place on the intercept aircraft 108.

FIG. 1G illustrates how a warhead or the kinetic projectile component 122 can be slid into or inserted into the intercept aircraft 108 using the track 140 and the attachment members 142. The kinetic projectile component 122 may be locked into place or may be removably configured on the intercept aircraft 108. The electrical connection to a detonator on the intercept aircraft 108 can be provided through the wiring 146 or can be configured or established through pins, a wireless communication channel using Bluetooth or other protocol.

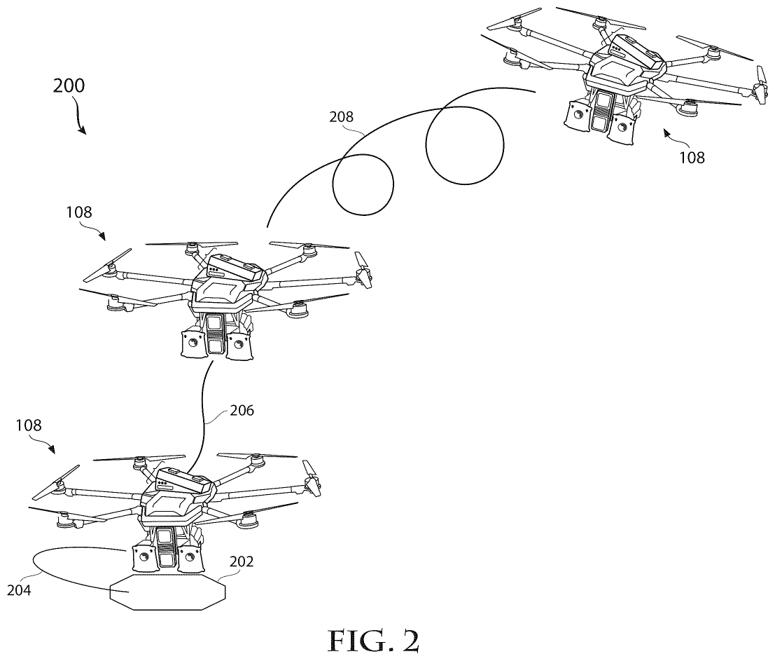

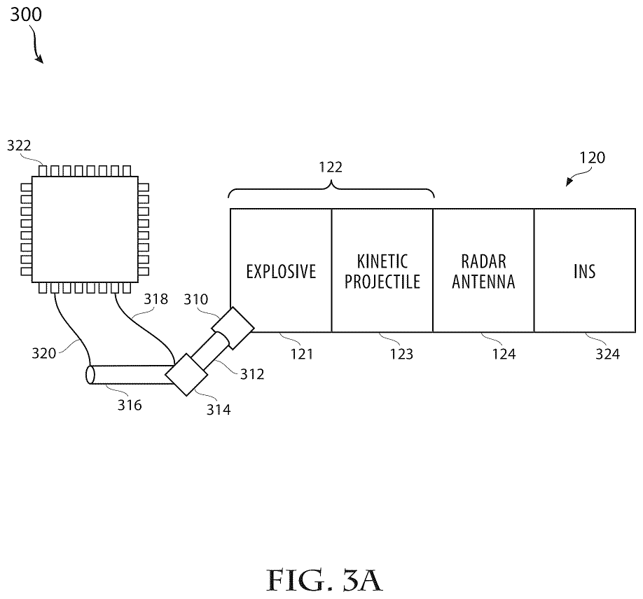

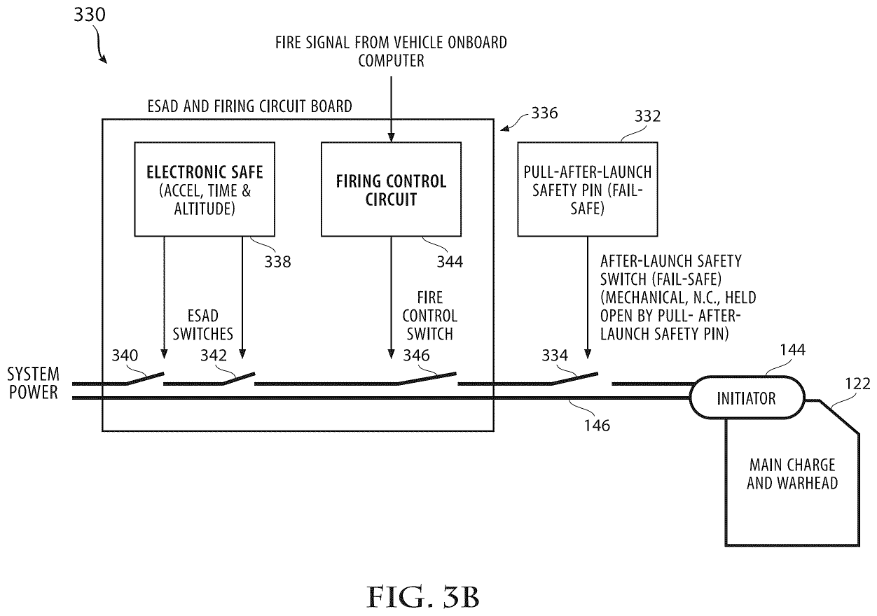

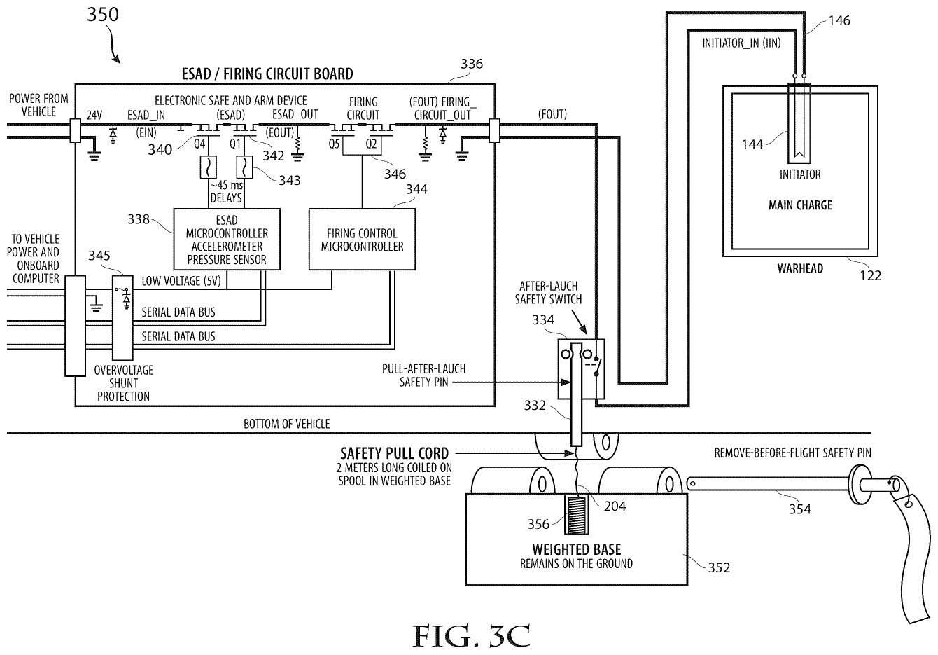

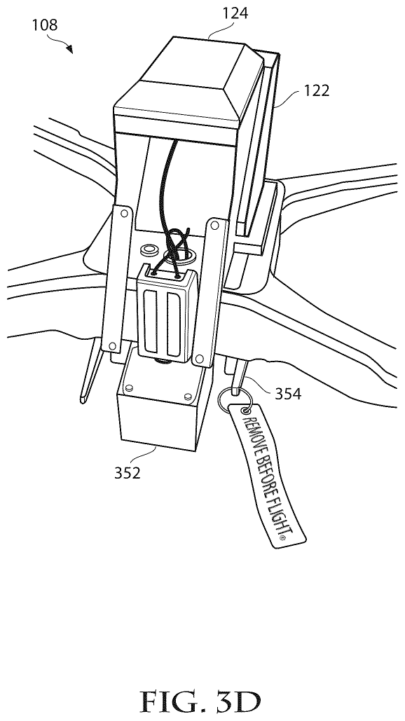

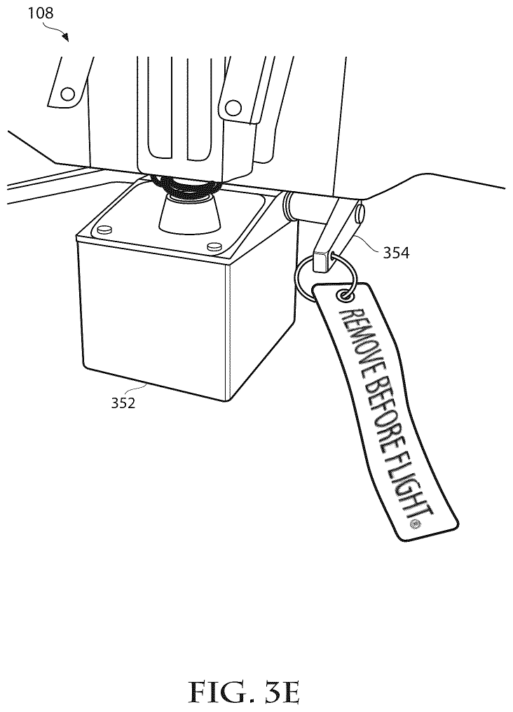

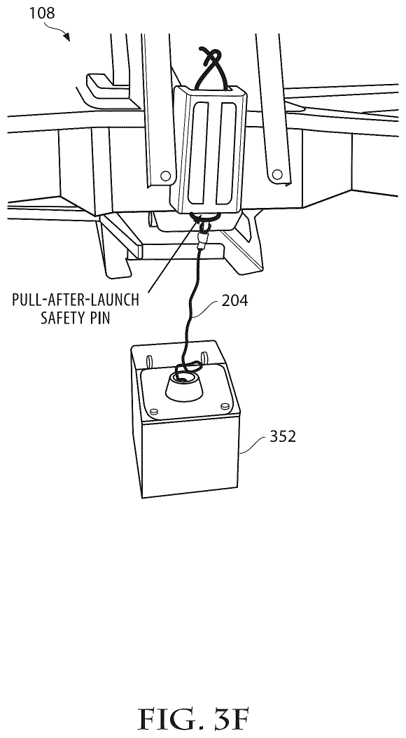

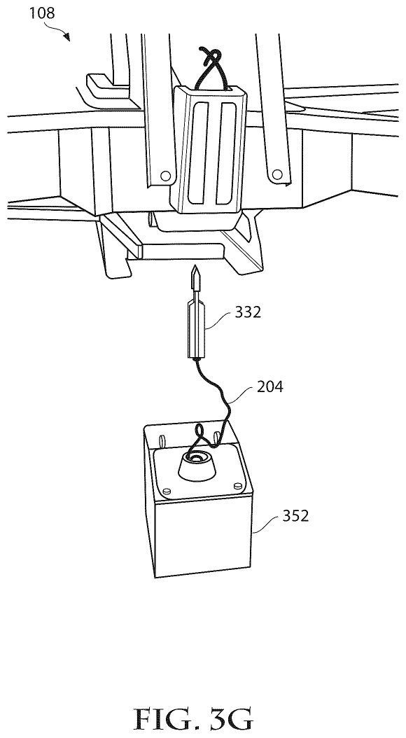

FIG. 2 illustrates an arming sequence 200 that satisfies various arming criteria (e.g., a first arming criterion 206 and a second arming criterion 208) such that the intercept aircraft 108 remains in a safe state until the arming criteria have been satisfied. While in the safe state, the intercept aircraft 108 is prevented from detonating the kinetic projectile component 122, which is discussed with reference to FIG. 3A. For example, when in the safe state, one or more obstacles (e.g., an open relay/switch) may be provided in the detonation path preventing a detonation signal from reaching the kinetic projectile component 122.

In one aspect, in the safe state, the intercept aircraft 108 could even crash on the ground or into another aircraft or object and the kinetic projectile component 122 would not explode.

When transitioning to the armed state, these obstacles can be removed to permit the detonation signal to reach a detonation device that detonates the kinetic projectile component 122. The obstacles can be electrical obstacles (e.g., relays), mechanical obstacles (e.g., mechanical barriers between a spring actuated striker and a percussion cap), some other obstacles, a condition such as a height, a speed, a maneuver achieved, a net has previously been deployed, or a combination thereof.

The intercept aircraft 108 is tethered via a cable 204 to the launch platform 202 or some other structure such as a weighted base 352 (shown in FIG. 3C) in a pre-armed state. When connected via a tether, the cable 204 or any other component or element, the intercept aircraft 108 can be considered a tethered device. At one end, the cable 204 connects to the intercept aircraft 108 via an engagement device that detachably connects the cable to the intercept aircraft 108. When a predefined force is applied to the cable as the intercept aircraft 108 lifts off of the launch platform 202 or weighted base 352, the cable 204 detaches from the intercept aircraft 108. The other end of the cable 204 is fixed to the launch platform 202 or weighted base 352, such that the cable 204 does not detach from the launch platform 202 or weighted base 352. As the intercept aircraft 108 flies away from the launch platform 202 or weighted base 352, the distance between intercept aircraft 108 and the launch platform 202 or weighted base 352 will eventually exceed the length of the cable 204, and the engagement device detaches the cable 204 from the intercept aircraft 108.

While the cable 204 is still engaged with the engagement device, detonation of the kinetic projectile component 122, can be prevented. The prevention of detonation can provide safety redundancy with the safe device/criteria. The length of the cable 204 or other cable characteristics can be selected based on a distance at which, if the kinetic projectile component 122 were detonated, the detonation would occur at a safe distance (e.g., not present a significant risk) with respect to people located either at the launch platform 202 or weighted base 352 or at a control center. That is, the length of the cable that is determined to be safe would depend on the particular circumstances of the amount of the kinetic projectile component 122, whether the operators are in an armored control box, etc.

FIG. 2 illustrates two additional safe arming criteria, in addition to the cable 204. In this non-limiting example, a first arming criterion 206 refers to a predefined change in altitude and (optionally or alternatively) within a predefined period (e.g., increase altitude by five-hundred meters in less than forty seconds). The first arming criterion 206 can be deemed satisfied when barometric measurements from an inertial measurement unit (IMU) on the intercept aircraft 108 have been processed by one or more processors to determine that the predefined change in altitude has occurred within the predefined period or time. The intercept aircraft 108 is still not armed at this stage because, in this non-limiting example, both the first arming criterion 206 and a second arming criterion 208 must be satisfied before arming occurs. Note that the multi-level arming criteria can be variable in that the first arming criterion 206 may be just a specific threshold altitude or may refer to a threshold time (thirty seconds after liftoff from the launch platform 202) and the second arming criterion 208 may be another altitude or a particular position over ground or a region of over the ground that the intercept aircraft 108 needs to enter. Any combination of two or more criteria may be met and the two criteria may also be of the same type or may be of a different type of criteria.

The second arming criterion 208 can be a predefined sequence of accelerations corresponding to a given aerobatic maneuver. The second arming criterion 208 may relate to when respective measurements from the IMU are processed to indicate that the acceleration values (e.g., based on accelerometer measurements) and orientation values (e.g., based on gyroscopic measurements and magnetometer measurements) occurred in a predefined sequence. For example, the sequence of values for an aerobatic maneuver can include the magnitude, duration, and order of acceleration values fall within predefined ranges, and that these occur while the intercept aircraft 108 goes through a predefined sequence of orientations. In FIG. 2, the second arming criterion 208 is illustrated as a series of three loops, but the aerobatic maneuver is not so limited when the second arming criterion 208 refers to a maneuver. As noted above, the second arming criterion 208 may relate to one or more of a time, an altitude, a region or a volume of airspace which the intercept aircraft 108 should enter, and so forth.

Significantly, at least two arming criteria are used because the redundancy provided by more than one arming criterion helps to ensure that the intercept aircraft 108 is not armed inadvertently. Extra precautions are applied for arming an arming device 314, which is discussed below with reference to FIG. 3A, due to the potential risks when the kinetic projectile component 122 is armed.

In contrast, fewer safe criteria can be required for transitioning from the armed state to the safe state. For example, the safe criteria can be a single criterion, and this single criterion can simply be an instruction (e.g., a communication received from a ground station such as the one or more communication towers 102) to return to the safe state. Additionally or alternatively, the safe criteria can be measurements from a global positioning system (GPS) or inertial measurement unit (IMU) indicating that the intercept aircraft 108 is in a region where the intercept aircraft 108 should return to the safe state (e.g., within a predefined distance of the launch platform 202). Additionally or alternatively, the safe criteria can be a signal that the threat presented by the target aircraft 110 has be averted.

In some aspects, the safe state may be returned to after the intercept aircraft 108 has been in an armed state for a period of time. For example, it may be expected that within thirty seconds after the

FIG. 3A shows the radar/kinetic projectile package 120 can include one or more of a kinetic projectile component 122, projectiles 123, explosives 121, and a radar antenna 124. The kinetic projectile component 122 is arranged to provide a directed charge through the projectiles 123, which can be metal pellets/fragments that are accelerated through the radar antenna 124 to generate additional high-velocity fragments.

The radar antenna 124 can have dual uses: (1) as part of a radar and (2) as shrapnel generated during the kinetic interception 134. First, the radar antenna 124 is used for seeking the target aircraft 110 and used for proximity fusing to determine when the target aircraft 110 is sufficiently close to detonate the kinetic projectile component 122. Second, the explosion of the explosives 121 in the kinetic projectile component 122 accelerates fragments of the radar antenna 124 to hit and cause damage to the target aircraft 110.

The intercept aircraft 108 can include an inertial navigation system or an INS 324 and one or more processors 322. The INS 324 can include one or more of a barometric pressure sensor, an inertial measurement unit (IMU) and a global positioning system (GPS), for example. The INS 324 can represent other sensors or control components as well. The IMU can be a 9-axis IMU that measures acceleration, magnetic fields, and rotations in three dimensions. The IMU can include accelerometers, magnetometers, and gyroscopes. The sensor data from the INS 324 can be processed by the one or more processors to determine whether the arming criteria or the safe criteria have been satisfied. For example, the one or more processors can include central processing units (CPUs), microcontrollers, microprocessors, field programable gate arrays (FPGAs), application-specific integrated circuits (ASICs), EPROMs, or other circuitry configured to perform logical operations. Various sensors can be provided on the intercept aircraft 108 for providing the sensor data.

The kinetic projectile component 122 is detonated by the detonation device 310, which receives a detonation signal via the detonation signal path 312. This detonation signal path 312 is interrupted/blocked by the arming device 314, which can include, e.g., an electrical relay, a mechanical device, or a combination thereof that prevents detonation while the arming device 314 is in a safe state. Further, the arming device 314 can have a fail-safe design, such that when the device is any one of the possible failure modes the arming device 314 prevents detonation.

The one or more processors can perform various computations to determine whether the arming criteria (or safe criteria) are satisfied, and the one or more processors 322 can send signals/instructions via the arming signal 318 to control the state of the arming device 314. Further, the one or more processors 322 can determine when detonation is to occur and send the detonation signal 320 along the detonation signal path 316.

According to certain non-limiting examples, the arming device 314 can include a mechanical barrier that is located after the detonation device 310, preventing the shockwave from the detonation device 310 from reaching the explosives 121 in the kinetic projectile component 122 and thereby preventing detonation of the kinetic projectile component 122.

According to certain non-limiting examples, the arming device 314 can be switched from the safe state to the armed state, and the arming device 314 can be switched back from the armed state to the safe state. While armed, the kinetic projectile component 122 presents a risk to people handling the intercept aircraft 108. After being armed, the intercept aircraft 108 may be in flight for an extended period resulting in the intercept aircraft 108 consuming most of its power reserves before encountering or engaging with a target aircraft 110, and the intercept aircraft 108 may need to return to the launch platform 202 to recharge/refuel. It is beneficial if the intercept aircraft 108 is in a safe state when returning and landing on the launch platform 202. After returning to the safe state, the intercept aircraft 108 can be handled with reduced risk to the handlers.

Further, there may be additional reasons for returning the intercept aircraft 108 to a safe state. For example, there may be certain regions over which detonation is not desirable, such as populated regions. Depending on the level of safety that is desired in these regions, the one or more processors 322 may include instructions to remain in the armed state but not to send a detonation signal, while flying in these no-detonation regions. If a greater degree of safety is required, the one or more processors 322 may include instructions to be in the safe state while flying in the no-detonation regions or airspace volumes. Then when the intercept aircraft 108 is next in a detonation region, the intercept aircraft 108 can rearm by going through the process of satisfying the arming criteria such that the intercept aircraft 108 can again switch back to the armed state. A third alternative can be to return to the safe state, but to only require a subset of the arming criteria to be satisfied again before switching back to the armed state. For example, according to certain non-limiting examples, it may be sufficient that only the second arming criterion 208 be satisfied again before switching back to the armed state.

The radar/kinetic projectile package 120 can be detachable from the body/fuselage of the intercept aircraft 108. For example, the radar/kinetic projectile package 120 can snap onto the body/fuselage of the intercept aircraft 108. According to certain non-limiting examples, after snapping onto the body of the intercept aircraft 108, the explosive device can be further secured at two or more points via fasteners extending through a housing of the explosive device and threading into the fuselage/body of the intercept aircraft 108. By detaching from the intercept aircraft 108, the explosives 121 in the kinetic projectile component 122 can be easier and safer to handle by itself.

FIG. 3A illustrates an example in which the one or more processors 322 and the INS 324 are fixed to the fuselage/body of the intercept aircraft 108. Alternatively or additionally, the one or more processors 322 and the INS 324 can include circuitry that is distributed such that some parts of the circuitry is fixed to the fuselage/body of the intercept aircraft 108 and other parts of the circuitry is fixed to the radar/kinetic projectile package 120 (e.g., fixed to a detachable member/housing that includes just the explosive device (e.g., the combination of the kinetic projectile component 122 or the explosives 121 and the projectiles 123). The other parts of the circuitry can include the radar/kinetic projectile package 120 (e.g., the combination of the kinetic projectile component 122 together with the projectiles 123, the radar antenna 124, and optionally other the radar components, such as RF mixers, RF amplifiers, A/D converters, band-pass filters, etc.).

For example, microcontrollers that are located on a detachable explosive device can be embedded in the arming device 314 and/or the detonation device 310. These can receive signals from the INS 324 and/or the radar to determine the arm/safe state of the intercept aircraft 108. Alternatively or additionally, a microcontroller located on the detonation device 310 can be used to control proximity fusing and to control firing/detonating the kinetic projectile component 122. According to certain non-limiting examples, separate microcontrollers for each of the arming criteria. Alternatively or additionally, multiple of the arming criteria can be handled by a single microcontroller.

When the explosive device is included in a detachable housing (i.e., can be detached from the fuselage/body of the intercept aircraft 108), a communication port can be included in the detachable housing for communications of the explosive device with the INS 324 and/or the one or more processors 322 at least one processor of the one or more processors.

According to certain non-limiting examples, the communication port is a wired port that electrically connects the projectile device to the flying machine when the projectile device is fixed to the flying machine. For example, the communication port can be a parallel port, a serial port, a DIN port, an RS-232C, an RS-422A, an RS-485, DE-9 port, a DB-25 port, a USB port, an ethernet port, a ruggedized port, or a firewire port. According to certain non-limiting examples, the communication port can provide electrical power from the intercept aircraft 108 to the explosive device. Further, the communication port can provide a detonation signal path 316 from the intercept aircraft 108 to the explosives 121 in the kinetic projectile component 122.

Alternatively or additionally, the intercept aircraft 108 can have a separate electrical power source than the detachable housing. That is, the intercept aircraft 108 can have an electrical power supply, and the explosive device, which snaps onto the intercept aircraft 108, can have another electrical power supply that is separate from the electrical power supply of the intercept aircraft 108.

According to certain non-limiting examples, the communication port is a wireless port. For example, the communication port can be a BLUETOOTH communication port, a BLUETOOTH LE communication port, a NEAR FIELD communication port, a ZIGBEE communication port, a Z-WAVE communication port, a 6LoWPAN communication port, a WIFI communication port, a 3G communication port, a 4G communication port, communication port, a 5G communication port, an LTE communication port, a secure communication port, or an encrypted communication port. Here, the intercept aircraft 108 can have a separate electrical power source than the detachable housing with the explosive device.

According to certain non-limiting examples, the kinetic projectile component 122 can be a liquid that is poured into a cavity (i.e., the inner volume of a container) that is determined to provide a desired dispersal pattern for the kinetic projectiles when the kinetic projectile component 122 is detonated. Advantageously, a liquid explosive can be a mixture of two or more binaries that are non-volatile or less volatile when they are stored separately, but, when mixed together, the mixture becomes volatile.

Handling explosives can be dangerous, and the protective measures adopted to account for this danger can be expensive. Thus, much of the expense and danger of the explosive can be mitigated by storing the non-volatile components and then, in response to a perceived threat, mixing the non-volatile components to obtain the explosive shortly before the explosive is to be used. This approach minimizes the amount of time when the explosive presents a risk, and by minimizing this time, the additional precautionary measures and expense of handling explosives can also be minimized.

Returning to FIG. 3A, the intercept aircraft 108 can include a flying device, such as a drone. The particular configuration of the drone can vary. While the term drone may be used herein, any flying device that has the components disclosed herein, and performs the functions described herein can apply. The intercept aircraft 108 can include circuitry (e.g., one or more processors) to control its operation. The circuitry can include the INS 324 and one or more processors 322. Further, the intercept aircraft 108 can include a radar that can identify a target aircraft 110 with which the intercept aircraft 108 desires to engage. The one or more processors 322 can provide movement instructions, and receive feedback from various components on the intercept aircraft 108. The intercept aircraft 108 also includes a projectile module (e.g., radar/kinetic projectile package 120) that is attached to the intercept aircraft 108 via an attachment member/mechanism. The projectile module can be snapped into the attachment member/mechanism in a single connecting motion.

In one aspect, the radar/kinetic projectile package 120 can include some or all of the computing capability necessary for running an algorithm to determine when to fire the kinetic projectile or the projectiles 123. In one aspect, some computing can occur on the radar/kinetic projectile package 120 and some computing can occur on the intercept aircraft 108. Wireless communication can occur between the flying device and the radar/kinetic projectile package 120 to communicate firing instructions according to any wireless protocol such as Near Field Communication or Bluetooth.

The flying device or intercept aircraft 108 can also encompass the following features. The one or more processors 322 can be part of a computing device or a control system. The flying device can include radar/kinetic projectile package 120 and a computer-readable storage medium storing instructions, which when executed by the processor, cause the processor to perform operations. The intercept aircraft 108 can include electrical communications between the controller and the radar/kinetic projectile package 120. These can be wired or wireless communications. For example, any wireless protocol such as Bluetooth can be utilized to communicate a triggering command from one or more processors 322 on the flying device or intercept aircraft 108.

In some aspects, the intercept aircraft 108 can be a flying machine that includes an explosive device that is attachable to a body of the flying machine. The explosive device (which can be the kinetic projectile component 122) can include a memory (i.e., a memory 608, or ROM 610 or RAM 612) that stores blast characteristics of an explosive on the explosive device. The blast characteristics can relate to whether the munition in the explosive device explodes up or at an angle, or down. The blast characteristics can include or relate to a shape of the explosive device or how it is attached or configured on the flying machine. An arming device can be configured to prevent detonating an explosive when in a safe state and allow detonating the explosive when in an armed state. One or more sensors on the flying machine can be configured to measure an acceleration, a position, and/or an environmental condition of the flying machine and to generate sensor data therefrom. One or more processors can be used in connection with a memory storing instructions that, when executed by the one or more processors, configure the flying machine to perform a number of steps.

The flying machine can receive the blast characteristics of the explosive from the explosive device and position the flying machine at an intercept point 132 relative to a target aircraft 110 based on the blast characteristics of the explosive. The flying machine can determine, based on the sensor data, whether two or more arming criteria are satisfied and signal the arming device to transition from the safe state to the armed state when the two or more arming criteria are satisfied. The flying machine can detonate the explosive, while in the armed state, when the flying machine is at the intercept point 132 relative to the target aircraft 110.

In one example, a method of operating an intercept aircraft 108 can include receiving an explosive device on the intercept aircraft 108; receiving blast characteristics of an explosive on the explosive device from a memory of the explosive device; move, based on the blast characteristics, the intercept aircraft 108 to an intercept point 132 relative to a target aircraft 110; and detonate the explosive on the explosive device when the intercept aircraft 108 reaches the intercept position relative to the target aircraft 110.

In another example, the intercept aircraft 108 and the kinetic projectile component 122 may be separately shipped to a field location where a user can then use the track 140 to insert or snap into place the kinetic projectile component 122 into the intercept aircraft 108. The blast characteristics or any other data related to characteristics of the munitions or explosive in the kinetic projectile component 122 may be preprogrammed or previously provided to the intercept aircraft 108 such that combining the two components, pulling the remove-before-flight safety pin 354 and launching the intercept aircraft 108 are as easy (and as fail safe) as possible.

FIG. 3B illustrates a diagram 330 of an example firing sequence for an explosive device. A kinetic projectile component 122 can include a main charge and warhead and can include a filler cap 144 and wiring 146. An after-launch safety pin 332 can be used in with the cable 204. The operation of the after-launch safety pin 332 can be where the cable 204 is pulled after the intercept aircraft 108 deploys. This can cause a mechanical component such as an after-launch safety switch 334 to be held open by the after-launch safety pin 332. This can represent a fail safe feature to ensure that the that the kinetic projectile component 122 is only activated meaning that the after-launch safety switch 334 is closed based on the after-launch safety pin 332 being pulled. The after-launch safety switch 334 is normally closed or is biased to a closed position. The after-launch safety pin 332 normally holds the after-launch safety switch 334 open which interrupts the final circuit to the initiator in the filler cap 144. The after-launch safety pin 332 is automatically pulled out during the launch of the intercept aircraft 108 by the cable 204 or safety pull cord. An electronic safe arming device (ESAD) and firing circuit board 336 can be used to provide further safety features. When the after-launch safety pin 332 is pulled, it allows the after-launch safety switch 334 to close which connects the final circuitry from the ESAD and firing circuit board 336 to the initiator.

The ESAD and firing circuit board 336 includes an electronic safe component 338 which can detect or sense features such as an acceleration (which can be obtained from an accelerometer), a time in flight (which can be obtained also from the accelerometer which is shown as part of the electronic safe component 338) and/or an altitude (which can be obtained from a pressure sensor or barometer to sense barometric pressure which is shown as part of the electronic safe component 338). In other words, the electronic safe component 338 can include a combination of features such as an ESAD microcontroller, an accelerometer and a pressure sensor. The system can establish threshold requirements for one of more of these sensed values. Other data can be sensed as well such as humidity, regular time, and so forth. A first switch 340 can be a MOSFET switch and a second switch 342, which can also be a MOSFET switch that can be initiated or switched on when the threshold for one of more feature or value are met. Another safety feature can be a firing control circuit 344 that also includes a fire control switch 346 which can, for example, be a MOSFET which is closed upon a fire signal being received from a control system such as a vehicle on-board computer, or from a remote location from a person or computer system via a wireless communication channel.

The ESAD and firing circuit board 336 can operate independently of a control system or onboard computer of the intercept aircraft 108. In some aspects, the ESAD and firing circuit board 336 do not use any input or communication from the onboard computer of the intercept aircraft 108 to operate.

The intercept aircraft 108 may include a set of different arming modes that can be chosen. The ESAD and firing circuit board 336 may store these various modes and get instructions or a selection of one of the modes from a remote computer system, or from a user who configures the intercept aircraft 108 for a mission. In another case, the intercept aircraft 108 may receive the kinetic projectile component 122 and the kinetic projectile component 122 may have in a memory the blast characteristics and/or other information associated with an arming mode to be selected. The intercept aircraft 108 may then automatically select an arming mode when the kinetic projectile component 122 is inserted. Some kind of indicator such as a sound or alight can inform a user that the arming mode is properly selected. The arming mode, as noted herein, can include characteristics such as a location of the intercept point 132, characteristics for the electronic safe component 338 to apply with respect to acceleration, time and altitude or other factors, how the firing control circuit 344 operates, how many switches to apply, and so forth. The intercept aircraft 108 may or may not have a user interface configured thereon which can enable the user to make such decisions regarding the arming mode or other instructions with respect to the operation of the intercept aircraft 108.

FIG. 3C illustrates a diagram of an example of an ESAD firing circuit design 350 and for arming an explosive device. The ESAD firing circuit design 350 can include the ESAD and firing circuit board 336 that is shown with the electronic safe component 338, the firing control circuit 344 and the first switch 340 (Q4), the second switch 342 (A1) and the fire control switch 346 (which can include two switches Q2 and Q5). The electronic safe component 338 can control the first switch 340 and the second switch 342 through a delay circuit 343. The firing control circuit 344 is shown as controlling the fire control switch 346. An overvoltage shunt protection 345 is shown as well with various data busses for communicating data. The after-launch safety pin 332 is shown with the after-launch safety switch 334.

Also shown in FIG. 3C is a remove-before-flight safety pin 354 connected to a weighted base 352. The cable 204 connects the weighted base 352 with the after-launch safety pin 332 which, when pulled closes the after-launch safety switch 334. Note that the weighted base 352 is configured to be attachable to the intercept aircraft 108 through the remove-before-flight safety pin 354 such that the weighted base 352 can be easily utilized to hold down the cable 204 upon launch such that the after-launch safety pin 332 can be pulled at the appropriate distance.

In some aspects, the safety features required for initiation and main charge to function can include a user pulling the remove-before-flight safety pin 354 and ensure that a battery is connected. The intercept aircraft 108 or vehicle is launched and the pull-after-launch safety

pin 332 is pulled when vehicle reaches a height of, for example, two meters. During flight, three environment conditions a tested or evaluated until they are met: a minimum accelerate for minimum time, a time in flight and an altitude. Other sensed values can be applied as well. The first switch 340 and the second switch 342 are closed. Targeting algorithms have flown the intercept aircraft 108 to the target aircraft 110. A final unique digital firing command from

vehicle onboard computer can be sent to the firing control circuit 344 to fire an initiator or blasting cap on the firing cap 144. In one example, the firing command is not a pulse but a unique data communication. The firing control circuit 344 sends signals to close the at least one fire control switch 346 and the initiator causes the main charge as shown in FIG. 3B is detonated. The vehicle onboard computer in one aspect determines that the intercept aircraft 108 is in position to detonate and sends a fire command to the firing control circuit 344. The firing control circuit 344 is an independent microcontroller that is waiting to receive a key or firing command from the vehicle onboard computer. Once received, the firing control circuit 344 sends a signal to close the fire control switch 346 to allow power to flow from the ESAD and firing control board 336 to the detonator or initiator in the firing cap 144.

The weighted base 352 can be held direction to a bottom surface of the intercept aircraft 108 with the remove-before-flight safety pin 354. When the remove-before-flight safety pin 354 is removed, it frees the weighted base 352 from the intercept aircraft 108. Before launching the intercept aircraft 108, the intercept aircraft 108 and the weighted base 352 can be loosely attached to each other. When the vehicle reaches, for example, a few meters above the ground, the weighted base 352 pulls the pull-after-launch safety pin 332 via the cable 204.

In one example, an intercept aircraft 108 can include an explosive device fixed to a body of the intercept aircraft 108; an arming device configured to prevent detonating an explosive when in a safe state and allow detonating the explosive when in an armed state; one or more sensors configured to measure an acceleration, a position, and/or an environmental condition of the intercept aircraft 108 and to generate sensor data therefrom; an after-launch safety pin 332 connected to an after-launch safety switch 334; and a weighted base 352 held in an attached position to the intercept aircraft 108 by a remove-before-flight safety pin 354.

Upon removal of the remove-before flight safety pin, the weighted base 352 is no longer in the attached position and only remains connected to the intercept aircraft 108 by a cable 204 attached to the after-launch safety pin 332. After the intercept aircraft 108 launches and reaches a length of the cable 204, the cable 204 causes the after-launch safety pin 332 to be pulled to close the after-launch safety switch 334. One or more processors and a memory storing instructions that, when executed by the one or more processors, can configure the intercept aircraft 108 to: determine, based on the sensor data, whether two or more arming criteria are satisfied, and signal the arming device to transition from the safe state to the armed state when the two or more arming criteria are satisfied and when the after-launch safety switch 334 is closed. The intercept aircraft 108 can be configured with any one or more of the safety pins and switches disclosed herein. For example, the intercept aircraft 108 may only include the weighted base 352 and remove-before-flight safety pin 354 which, when removed, enables the weighted base 352 to only be connected to the intercept aircraft 108 by the cable 204 which is connected to the after-launch safety pin 332.

FIG. 3D illustrates a weighted base 352 configured with an intercept aircraft 108. This figure illustrates also the remove-before-flight safety pin 354 and provides an example of the relationship between these components and the intercept aircraft 108.

FIG. 3E illustrates another view of the weighted base 352 configured with the intercept aircraft 108 and the remove-before-flight safety pin 354.

FIG. 3F illustrates another view of the cable 204 or safety pull cord attached to the weighted base 352 and configured with the intercept aircraft 108. FIG. 3G illustrates a view of the cable 204 or safety pull cord attached to the weighted base 352 and in a state of having been pulled from the intercept aircraft 108.

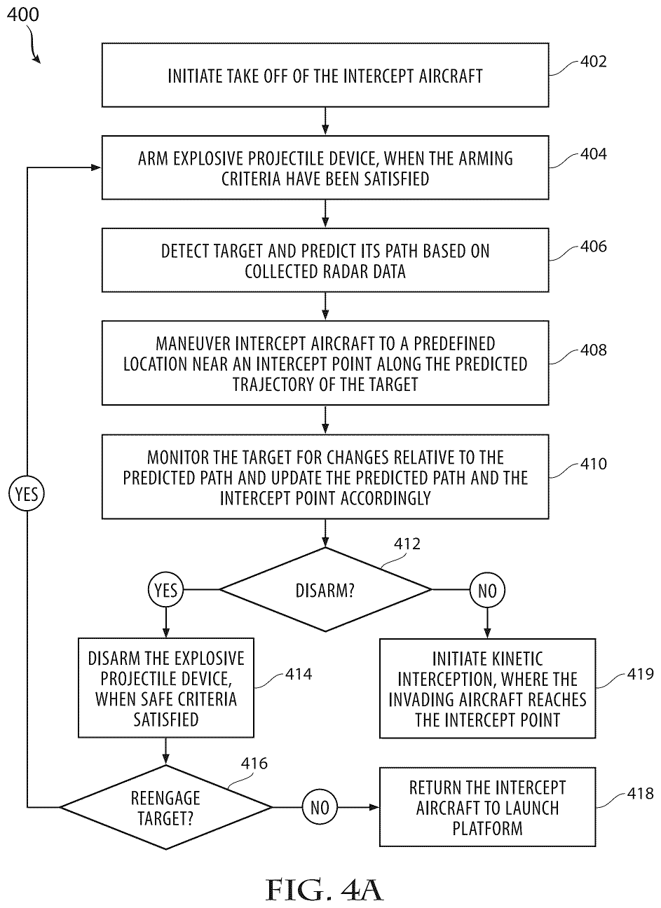

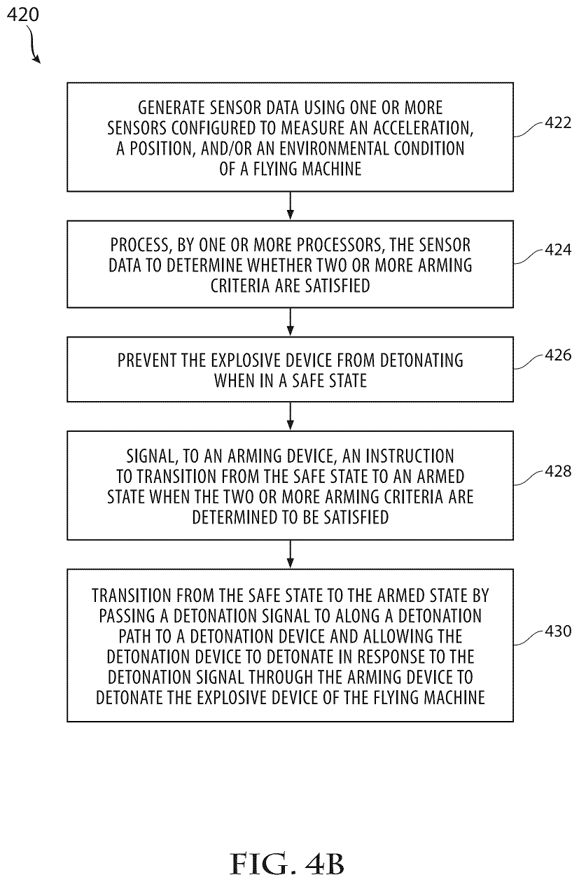

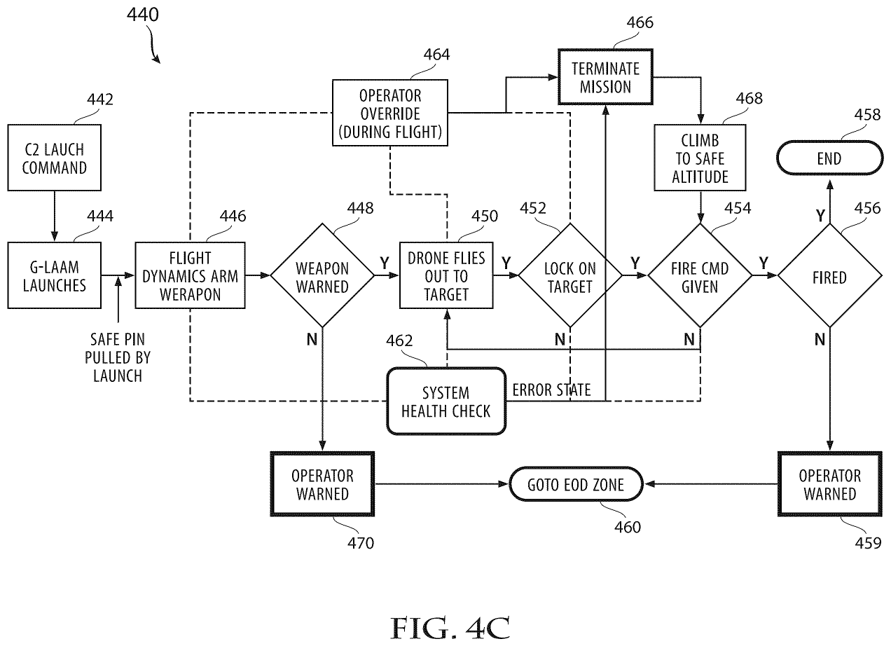

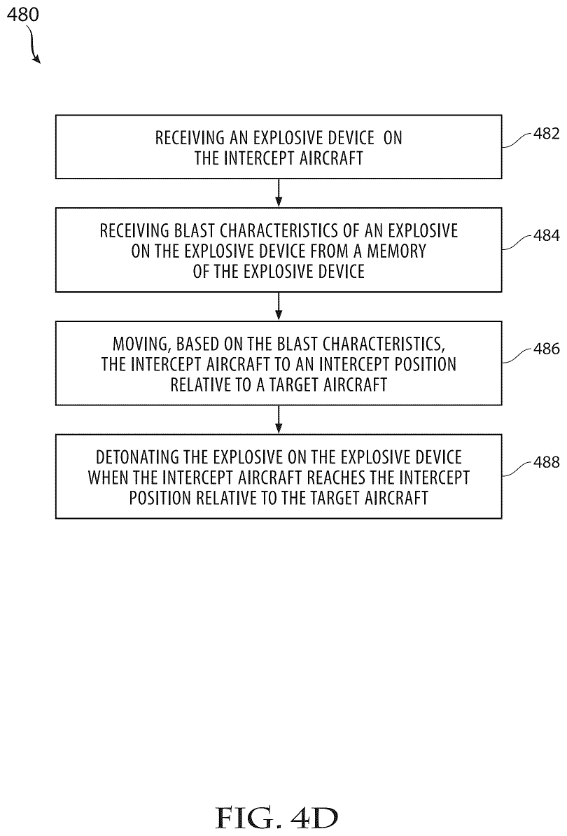

FIG. 4A illustrates an example method 400 for arming an explosive device that is used by an intercept aircraft 108 to intercept a target aircraft 110 (e.g., an intruding aircraft). Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, at step 402, the intercept aircraft 108 takes off from a launch pad, for example. The intercept aircraft 108 can be a quadcopter that performs vertical takeoff and landing.

The intercept aircraft 108 can include an engagement device that is engaged while the intercept aircraft 108 is within a specified distance of the launch pad. For example, when armed, the explosives 121 in the kinetic projectile component 122 may have a specified exclusion zone within which it is unsafe for people to be. The engagement device can prevent detonation of the explosives 121 in the kinetic projectile component 122 while the launch pad is within the exclusion zone of the intercept aircraft 108. When the intercept aircraft 108 flies away from the launch pad and is at a distance that exceeds the length of the cable, the engagement device disengages from the intercept aircraft 108 the engagement device ceases to prevent the detonation of the explosives 121 in the kinetic projectile component 122. For example, the engagement device can be a pin or other mechanical member that is removed from the intercept aircraft 108 upon the application a specified force, and the engagement device is fixed to an end of a cable 204, such that the force to detach the engagement device can be applied by pulling on the cable 204. The other end of the cable can be fixed to a launch pad. Once the distance from the launch pad to the intercept aircraft 108 exceeds the length of the cable, the pin will slide of the opening. The pin in the opening can prevent a circuit or detonation path from closing, such that the absence of the pin from the opening allows the circuit or detonation path to close thereby removing an obstacle from the detonation path.

According to some examples, at step 404, the intercept aircraft 108 arms the explosives 121 in the kinetic projectile component 122, when a criteria is met or in some aspects, where two or more arming criteria have been satisfied. Multiple unique arming criteria can be used to help ensure that the explosives 121 in the kinetic projectile component 122 is not accidentally armed. For example, the arming criteria can include a pattern of accelerations that are unlikely to occur by accident coupled with an altitude change that is unlike to occur by accident.

For example, if the electronics of the intercept aircraft 108 remain on during transport, some accelerations may occur when the intercept aircraft 108 is being transported (e.g., due to road vibrations, due to accelerating and braking the transport vehicle, or due to the transport vehicle being in an accident), but these are likely to be either small accelerations in one direction of a long duration or large accelerations of a short duration. Accordingly, the possible accidental accelerations are unlikely to satisfy an arming criterion for accelerations matching an aerobatic maneuver because the combinations of accelerations arising during transportation are unlikely to replicate the particular pattern of accelerations (e.g., the magnitude, sequence, and durations of accelerations) that are experienced by the intercept aircraft 108 when performing a sequence of acrobatic maneuvers. Moreover, the sequence of acrobatic maneuvers used as a signature for arming can be selected to minimize the likelihood of the corresponding acceleration patterns being replicated by accident.

Additionally or alternatively, one of the arming criteria can be a signature of barometric values in the sensor data that indicate a predefined change in the altitude of the intercept aircraft 108 within a given period. For example, upon being launched, a drone may be capable of a climb rate of 25 m/s. Further, the intercept aircraft 108 may typically operate at an elevation of one thousand meters or higher. Thus, an arming criterion may be that the intercept aircraft 108 increases altitude by five hundred meters within a forty-second time interval. Such a condition is unlikely to occur accidentally because increasing altitude (as opposed to falling/decreasing altitude) by such a large value is unlikely to occur by accident. Further, increasing altitude by five hundred meters within a forty-second time interval is unlikely unless the intercept aircraft 108 is expressly instructed to do so.

Additionally, the combination of a first criterion of a predefined change in altitude within a predefined window (e.g., increasing altitude by five hundred meters within forty seconds) and a second criterion of a predefined sequence of accelerations corresponding to a series of aerobatic maneuvers can substantially decrease the likelihood of accidentally arming the explosives 121 in the kinetic projectile component 122. For example, if the probability of the first criterion is statistically independent of (e.g., uncorrelated with) the second criterion, then the probability of the combination of criteria accidentally occurring is the product of each probability of the separate criterion separately accidentally occurring. That is, if the probability of the first criterion accidentally occurring is P₁ and the probability of the second criterion accidentally occurring is P₂, the probability of the combination accidentally occurring is P_{C}=P₁×P₂.

According to some examples, the method includes detecting the target and predicting its prospective path based on the radar data, at step 406.

For example, the target aircraft 110 can be detected by one or more radars in the aircraft environment 100, including, e.g., the one or more satellite 104, the one or more ground-based radar and camera system 106, or the radar on the intercept aircraft 108. For example, the radar on the intercept aircraft 108 can function as a seeker to detect and monitor the position of the target aircraft 110.

According to certain non-limiting examples, the intercept aircraft 108 includes a radar (i.e., radar or the set of antenna arrays 115) that detects the target aircraft 110 by transmitting a radio signal and then detecting the scattered radio signal from the target aircraft 110. The radar can use an FMCW radar mode and a phased array antenna. Further, based on the measurements of the scattered radio signal, the radar can determine the relative distance (range), angle (e.g., azimuthal angle and elevation angle), and speed of the target aircraft 110 relative to the intercept aircraft 108. That is, based on the measured scattered radio signal, the intercept aircraft 108 can determine the position (e.g., distance and angle) and the velocity of the target aircraft 110. Further, by monitoring the position and velocity of the target aircraft 110 over time, the intercept aircraft 108 can predict where the target aircraft 110 is going in the future (i.e., the prospective path of the target aircraft 110).

According to some examples, in step 406, the prospective/future path of the target aircraft 110 (i.e., the predicted path 130) is predicted using the collected radar data. The predicted path 130 can be based on measurements of the position, velocity, angle, acceleration, and change in the direction of the target aircraft 110 at a series of times. As discussed below with respect to step 410, the radar measurements can be ongoing, and the predicted path 130 can be updated based on the ongoing radar measurements. These radar measurements can include measurements by the radar on the intercept aircraft 108 as well as measurements by other radars in the aircraft environment 100, including, e.g., the one or more satellites 104 and the one or more ground-based radar and camera system 106.

According to some examples, in step 408, an intercept point is selected along the predicted path 130, and the intercept aircraft 108 is directed to fly to a predefined location with respect to the intercept point 132 along the predicted path 130 of the target aircraft 110.

According to certain non-limiting examples, the intercept aircraft 108 includes a kinetic interception device that shoots projectiles in an upward direction. The intercept aircraft 108 hovers in place waiting for the target aircraft 110 to pass above the intercept aircraft 108. At a predefined time interval before the target aircraft 110 passes through intercept point 132, an explosives 121 in the kinetic projectile component 122 is detonated launching the projectiles 123 to hit the target aircraft 110 when it reaches intercept point 132. The time delay associated with the electronics, detonation process, and travel of the projectiles 123 to intercept point 132 can be precisely determined to ensure the projectiles 123 hit the target aircraft 110 thereby ensuring the effectiveness of the kinetic interception for disabling the target aircraft 110.

The intercept aircraft 108 can be guided to the intercept point 132, which can be determined based on the specific payload or based on the characteristics of the kinetic projectile component 122. For example, the intercept point 132 can be optimal for a specific payload (i.e., the explosive characteristics of the munitions in the kinetic projectile component 122) which can, for example, two meters below and at an angle to the target aircraft 110. In some aspects, the payload may explode straight up. In that case, the intercept point 132 may be right below the target aircraft 110. A radar can guide the intercept aircraft 108 to the intercept point 132 and the systems disclosed therein can cause the payload to be detonated at the appropriate position.

In some cases, the kinetic projectile component 122 can include circuitry or a microcontroller that can store information about the characteristics of the munition in the kinetic projectile component 122. For example, data about a blast zone or blast characteristics for the payload can be transferred from the kinetic projectile component 122 to the intercept aircraft 108 to cause a system on the intercept aircraft 108 to select a certain intercept point 132 or other aspect of the flight, or time, or speed, and so forth for how the intercept aircraft 108 travels and positions itself relative to the target aircraft 110. Timing aspects, positional features and so forth can be determined based on data received from the kinetic projectile component 122 that can be plugged into or snapped into a receiving structure on the intercept aircraft 108. See FIG. 1G for a track 140 used to receive and snap in the kinetic projectile component 122.

According to some examples, in step 410, the position and velocity of the target aircraft 110 continue to be monitored, and the predicted path 130 is updated based on the updated position and angle from the intercept aircraft 108 to the target aircraft 110. As the predicted path 130 is updated, the intercept point 132 is also updated to reflect the changes in the updated predicted path 130, and the location of the intercept aircraft 108 is adjusted accordingly.

At decision block 412, various contingencies are considered whether the intercept aircraft 108 should be disarmed. When it is determined not to disarm the intercept aircraft 108, method 400 proceeds from decision block 412 to step 419 in which the operation is to initiate kinetic interception where the invading aircraft reaches the intercept point. Otherwise, method 400 proceeds from decision block 412 to step 414 which includes disarming the kinetic projectile package 120 when a safe criterion is satisfied.

According to some examples, in step 419, the kinetic interception 134 is initiated at a predefined time before the target aircraft 110 reaches the intercept point 132. For example, this predefined time can account for the propagation delays through the electronics and the time from detonation until the projectiles 123 reach intercept point 132. The radar on the intercept aircraft 108 can use the same radar mode that is used for seeking the target aircraft 110 to function as a proximity fuse (i.e., the radar beneficially does not require switching modes to perform both seeking and proximity fusing functions).

According to some examples, in step 414, one or more processors 322 analyze whether the safe criteria have been satisfied, and, when they are satisfied, the arming device 314 is modified to introduce one or more obstructions in the detonation signal 320, returning the intercept aircraft 108 to a safe state from the armed state.

As discussed above, the safe criteria can include a single criterion or multiple criteria that each must be satisfied. Additionally, there may be different alternative safe criteria, any of which will be sufficient to return the intercept aircraft 108 to the safe state.

For example, one criterion can be that, if the explosives 121 in the kinetic projectile component 122 has not detonated after a predefined period, then the intercept aircraft 108 returns to the safe state. Additionally or alternatively, one criterion can be that, if the power reserves of the intercept aircraft 108 fall below a predefined threshold, then the intercept aircraft 108 returns to the safe state. Additionally or alternatively, one criterion can be that, if the intercept aircraft 108 receives an instruction to disarm (e.g., from the one or more communication towers 102 or another device) falls below a predefined threshold, then the intercept aircraft 108 returns to the safe state. According to certain non-limiting examples, the instruction to disarm can be encrypted or on a secure channel to avoid enemies disarming the intercept aircraft 108. Additionally or alternatively, one criterion can be that, if the intercept aircraft 108 enters a protected region or airspace three-dimensional volume, then the intercept aircraft 108 returns to the safe state.

Additionally or alternatively, one criterion can be that, if the intercept aircraft 108 determines that it is damaged/disabled to the point it cannot complete its mission, then the intercept aircraft 108 can return to the safe state or, if the intercept aircraft 108 is unable to return to location where it can be retrieved, the intercept aircraft 108 can self-destruct to prevent bad actors from savaging the remnants of the intercept aircraft 108 and reverse engineering secret/protected technologies therein.

According to some examples, in block 416, an inquiry is performed regarding whether to reengage the target aircraft 110. If the decision is to reengage the target aircraft 110, method 400 returns to step 404, and the intercept aircraft 108 performs various actions to satisfy the arming criteria such that the intercept aircraft 108 can switch from the safe state to the armed state. Otherwise, the intercept aircraft 108 remains in the safe state and returns to the launch platform 202 as shown in block 418.

FIG. 4B illustrates a method 420 for arming an explosive device on an aircraft. The method 420 can be practiced by a system such as an intercept aircraft 108 or any subcomponent thereof.

At block 422, a system such as the intercept aircraft 108 or any subcomponent thereof, can be configured to generate sensor data using one or more sensors configured to measure an acceleration, a position, and/or an environmental condition of a flying machine.

At block 424, a system can be configured to process the sensor data to determine whether two or more arming criteria are satisfied. Alternatively, any single criteria could be used as well.

At block 426, a system can be configured to prevent the explosive device from detonating when in a safe state.

At block 428, a system can be configured to signal, to an arming device, an instruction to transition from the safe state to an armed state when the two or more arming criteria are determined to be satisfied. Alternatively, any single criteria could be used as well.

At block 430, a system can be configured to transition from the safe state to the armed state by passing a detonation signal to along a detonation path to a detonation device and allow the detonation device to detonate in response to the detonation signal through the arming device to detonate the explosive device of the flying machine.

In some aspects, the method 420 can further include a system being configured to tether an engagement member to a launch platform 202 or weighted base 352 via a cable 204 or some other tether or connection member. In some aspects, a length of the cable 204 can exceed a predefined distance within which an explosion is not permitted, such that, when the flying machine such as the intercept aircraft 108 is separated from the launch platform 202 or weighted base 352 by more than the length of the cable, the cable disengages from the engagement member.

In some aspects, while the engagement member is engaged with the cable, the engagement member prevents detonating the explosive device. When the engagement member is disengaged from the cable, the engagement member can cease to prevent detonating the explosive device.

In some aspects, the one or more sensors can include an inertial measurement unit (IMU) including one or more of an accelerometer, a gyroscope, and/or a magnetometer to measure inertial navigation data. The sensor data can include the inertial navigation data.

The arming device 314 can include a relay that causes an open circuit when in the safe state and the relay causes a closed circuit when in the armed state, such that the detonation signal can pass through the relay to a detonator of the explosive device.

In some aspects, the method 420 can include two or more arming criteria such as: a first determination that the flying machine has undergone the acceleration exceeding an acceleration threshold for a predefined time period; a second determination, based on barometer data which is included in the sensor data, that the flying machine has reached a predefined altitude relative to a launch altitude; a predefined change in barometer values of the barometer data; and/or a third determination, based on magnetometer data which is included in the sensor data, that the flying machine has reached the predefined altitude relative to the launch altitude.

In some aspects, the two or more arming criteria can include a determination that the flying machine has undergone a predefined pattern of accelerations and changes in altitude that indicate the flying machine has executed one or more acrobatic maneuvers. The one or more acrobatic maneuvers can include: a predefined sequence of one or more barrel roles, a predefined sequence of one or more S-curves, a predefined sequence of one or more loops, a predefined sequence of one or more rolls, a predefined sequence of one or more FIG. 8's, a predefined sequence of one or more spins, a predefined sequence of one or more hammerhead stall turns, or a combination thereof.

The method 420 can further cause the system to be configured to cause the explosive device to be in a safe state by switching the arming device from the armed state to the safe state, when one or more safe criteria have been satisfied. The one or more safe criteria can include: that a power reserve of the flying machine has fallen below a predefined level, the flying machine has entered a space where detonation of the explosive device is not permitted, the flying machine is returning to a launch location, or the flying machine receives a communication with an instruction to switch to the safe state.

In some aspects, an explosive device is configured to attach to a flying machine. The explosive device can include an explosive; a detonation device configured to detonate the explosive; and a detonation signal system between the detonation device and a detonation source, the detonation signal system including a detonation signal path and an arming device. The detonation signal path can be configured to conduct a detonation signal from the detonation source to the detonation device. In some aspects, the arming device can be configured to prevent detonating an explosive when in a safe state and allow detonating the explosive when in an armed state.

The explosive device further can include one or more processors; and a memory storing instructions that, when executed by the one or more processors, configure the explosive device to: determine, based on sensor data of an inertial measurement unit (IMU), whether two or more arming criteria are satisfied, and signal the arming device to transition from the safe state to the armed state when the two or more arming criteria are satisfied.

When in the safe state, the arming device can prevent the detonation device from detonating in response to having received the detonation signal and/or interrupts the detonation signal path from transmitting the detonation signal to the detonation device.

The explosive device can be attached to the flying machine that is a vertical-take-off-and-landing flying machine. Note as well that the explosive device can include blast characteristics of the explosive and is configured to attach to the flying machine. The blast characteristics can cause the flying machine to position itself, based on the blast characteristics, relative to a target aircraft. An electrical wire, pin or wireless communication can provide the blast characteristics of the explosive from the kinetic projectile component 122 to the intercept aircraft 108 in any number of different ways. The intercept aircraft 108 can then select a flight pattern or positioning decision, selectable in some aspects from a plurality of choices of positioning options (i.e., above or below the target aircraft 100, two meters below and to the side of the target aircraft 110, etc.), and carry out the flight pattern or positioning decision before detonating an explosive.

In some aspects, the intercept aircraft 108 can include one or more of: an explosive device attached to a body of the intercept aircraft 108, the explosive device comprising a memory storing blast characteristics of an explosive; an arming device configured to prevent detonating an explosive when in a safe state and allow detonating the explosive when in an armed state; one or more processors; and a memory storing instructions that, when executed by the one or more processors, configure the intercept aircraft 108 to: receive the blast characteristics of the explosive; select an arming mode from a plurality of arming modes based on the blast characteristics, the arming mode implemented by the arming device; and control the intercept aircraft 108 to fly to an intercept position and detonate the explosive based on the arming mode.

The intercept aircraft 108 can further include: one or more sensors configured to measure an acceleration, a position, and/or an environmental condition of the intercept aircraft 108 and to generate sensor data therefrom; an after-launch safety pin connected to an after-launch safety switch; a weighted base held in an attached position to the intercept aircraft 108 by a remove-before flight safety pin. Upon removal of the remove-before flight safety pin, the weighted base is no longer in the attached position and only remains connected to the intercept aircraft 108 by a cable 204 attached to the after-launch safety pin. After the intercept aircraft 108 launches and reaches a length of the tether, the cable 204 causes the after-launch safety pin to be pulled to close the after-launch safety switch.

In some aspects, the one or more processors are configured to determine, based on the sensor data, whether two or more arming criteria are satisfied, and signal the arming device to transition from the safe state to the armed state when the two or more arming criteria are satisfied and when the after-launch safety switch is closed.

In some aspects, a user interface may confirm that the right arming mode is established. There may be a physical pin structure that is configured om the kinetic projectile component 122 to cause a physical connection to cause the intercept aircraft 108 to be set to the proper arming mode (without user interaction or the chance for user error).

In some aspects, the intercept aircraft 108 can have the ability for radio communication or wireless communication with a remote device or server 107. The server 107 or device can track the various operations that occur with the intercept aircraft 108 where in case of an error or a lack of a completion of a specific step and so forth the server 107 can send an abort signal and cause the mission to abort, or cause the intercept aircraft 108 to destroy itself, or may turn off one or more of the disclosed switches to prevent the detonation of the explosive on the kinetic projectile component 122. The server 107 may be remote or accessible through a radio communication with the intercept aircraft 108 directly or through a network.

FIG. 4C illustrates a state overview 440 for safety procedures for the intercept aircraft 108. First, in block 442, a control launch command is initiated followed by, at block 444, a ground launched air-to-air munition (G-LAAM) launch. The launch can be automated or manually provided. A safety pin (the pull-after-launch safety pin 332) is pulled at launch and at block 446, the system arms a weapon. At block 448, the system determines if the weapon is armed. If yes, the intercept aircraft 108 at block 450 flies out to the target aircraft 110 and at block 452 seeks to lock on the target aircraft 110. If the intercept aircraft 108 properly locks on the target aircraft 110, in block 454, a fire command is provided. If the fire command is properly provided, then the munition from the kinetic projectile component 122 is fired at block 456 and the process ends at block 458. The operator may also be warned in block 459 if the firing does not occur. The operator may be an algorithm operating on the intercept aircraft 108 or may be a person viewing the data on the server 107. In that case, the operator may cause the intercept aircraft 108 to go to the EOD zone in block 460.

A system health check at block 462 continues to monitor for an error state from the various steps. If block 462 indicates an error state at the various stages that is monitors, it can send an error state message to block 466 to terminate the mission. An error state can include a low battery condition, a communication loss before locking in the target aircraft 110, a failure to arm, or other error states that can jeopardize the mission or be dangerous. At block 464, an operator can send an override message during flight and terminate the mission in block 466. In one aspect, to terminate the mission as in block 466, the system can, at block 468, cause the intercept aircraft 108 to climb to a safe altitude and then, via block 454, cause the fire command to be initiated to fire, via block 456 the munition and destroy the intercept aircraft 108 in a safe location.

The system health check at block 462 can occur as shown view the dotted lines at various stages of the process in which an error state or instructions can be sent to terminate the mission in block 466.

Block 466 may represent a terminate mission decision on the intercept aircraft 108 or may refer to a decision made at a server 107 at a remote location that communicates with the intercept aircraft 108.

If the weapon is not armed in block 448, then a signal is sent and block 470 relates to an operator (again, a human operator or an algorithm that will perform the necessary or programmed function of sending the intercept aircraft 108 to a proper zone) being warned and the intercept aircraft 108 can be send to an explosive ordinance disposal (EOD) zone in block 460. This can relate to a location where it is safe to fire the munition and destroy the intercept aircraft 108.

If the intercept aircraft 108 does not lock on the target from block 452 or if no fire command is provided, the process returns to block 450 to cause the intercept aircraft 108 to continue to fly to the target aircraft 110. The intercept aircraft 108 uses its radar to lock onto the target aircraft 110. At any of the steps do not occur such as it does not lock on the target aircraft 110, while continuing to find the target aircraft 110, and continue to try and lock on. An operator may notice that things are not progressing in the normal fashion. The operator can, in block 464, override during the flight the operations of the intercept aircraft 108 to terminate the mission at block 466.

All of the states described above can be controlled based on circuits or a control system on the intercept aircraft 108 or may be in part controlled by an operator at the server 107.

FIG. 4D illustrates a method 480 for use in an intercept aircraft 108. At block 482, the method 480 can cause the intercept aircraft 108 or any subcomponent or computing device thereof, to be configured to receive an explosive device (such as the kinetic projectile component 122) on the intercept aircraft 108. This can occur as shown in FIG. 1G with the kinetic projectile component 122 sliding in and locking into place using a track 140.

At block 484, the intercept aircraft 108 or any subcomponent or computing device thereof, to be configured to receive blast characteristics of an explosive on the explosive device from a memory of the explosive device.

At block 486, the intercept aircraft 108 or any subcomponent or computing device thereof, to be configured to move, based on the blast characteristics, the intercept aircraft 108 to an intercept point 132 relative to a target aircraft 110.

At block 488, the intercept aircraft 108 or any subcomponent or computing device thereof, to be configured to detonate the explosive on the explosive device when the intercept aircraft 108 reaches the intercept point 132 relative to the target aircraft 110.

Other steps of method 480 can include any one or more of the disclosed operations such as determining, based on the sensor data, whether two or more arming criteria are satisfied and signaling an arming device to transition from a safe state to an armed state when the two or more arming criteria are satisfied and then detonating the explosive, while in the armed state, when the intercept aircraft 108 is at the intercept point 132 relative to the target aircraft 110.

In some aspects, an intercept aircraft 108 can include an explosive device that is attachable to a body of the intercept aircraft 108, the explosive device including a memory that stores blast characteristics of an explosive on the explosive device; an arming device configured to prevent detonating an explosive when in a safe state and allow detonating the explosive when in an armed state; one or more sensors configured to measure an acceleration, a position, and/or an environmental condition of the intercept aircraft 108 and to generate sensor data therefrom; one or more processors; and a memory storing instructions.

The instructions, when executed by the one or more processors, configure the intercept aircraft 108 to: receive the blast characteristics of the explosive from the explosive device; position the flying machine at an intercept position relative to a target aircraft based on the blast characteristics of the explosive; determine, based on the sensor data, whether two or more arming criteria are satisfied, signal the arming device to transition from the safe state to the armed state when the two or more arming criteria are satisfied; and detonate the explosive, while in the armed state, when the flying machine is at the intercept position relative to the target aircraft.

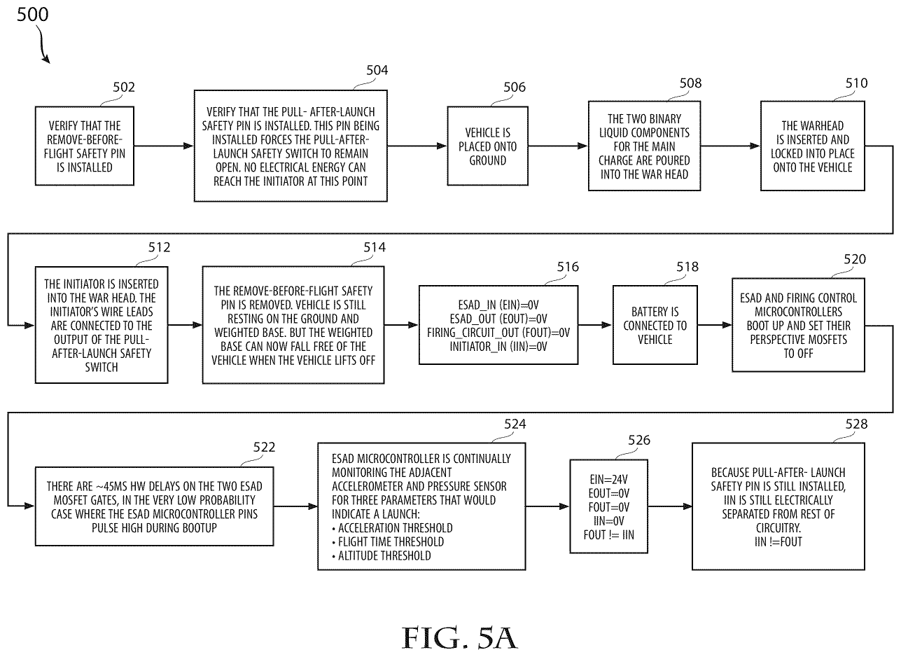

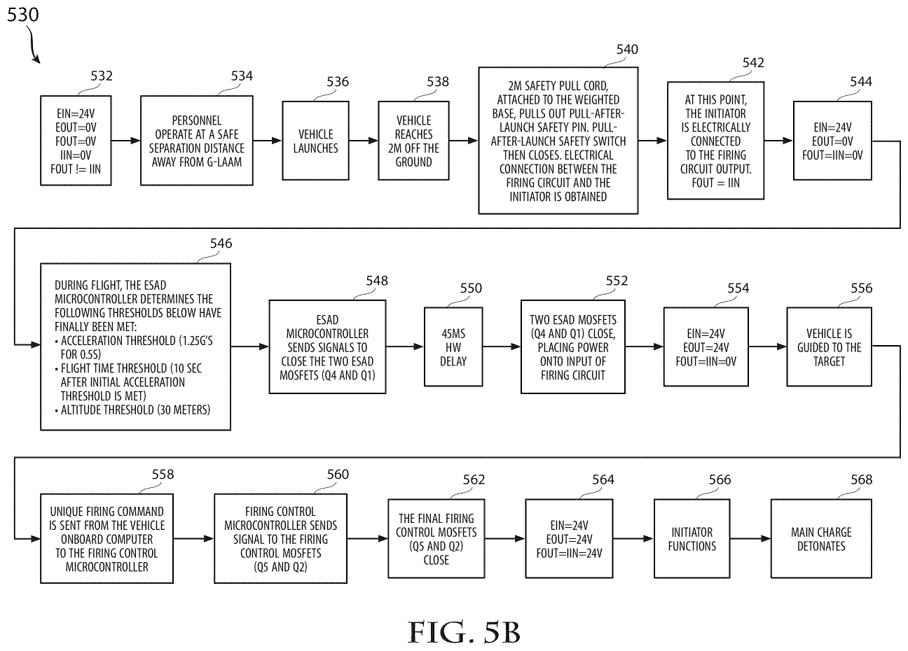

FIG. 5A illustrates a diagram of an initial setup for a ground-launched air-to-air munition 500. An initial setup can include, at block 502, to verify that the remove-before-flight safety pin 354 is installed and at block 504, verify that the pull-after-launch safety pin 332 is installed which forces the pull-after-launch safety switch to remain open. At this stage, no electrical energy can reach the initiator. At block 506, the intercept aircraft 108 is placed on the ground and at block 508, two binary liquid components for the main charge are poured into the warhead or the kinetic projectile component 122. There are various ways of generating the munition used for detonation and using two binary liquids is one example. At block 510, the warhead is inserted and locked into place on the intercept aircraft 108 as is shown in FIG. 1G. At block 512, an initiator is inserted into the warhead or kinetic projectile component 122. The wire leads or wiring is connected to an output of the pull-after-launch safety switch. At block 514, the remove-before-flight safety pin 354 is removed and the intercept aircraft 108 is still resting on the ground with the weighted base 352. The weighed base 352 can fall free of the intercept aircraft 108 when the intercept aircraft 108 lifts off. At bock 416, various voltages for various components are set at or are at zero volts: ESAD_In (EIN); ESAD_OUT (EOUT); FIRING)_CIRCUIT_OUT (FOUT) and INITIATOR_IN (IIN). FIG. 3C references the various locations of these voltages. At block 518, a battery is connected to the intercept aircraft 108 and at block 520, the ESAD and firing circuit board 336 boot up and set respective switches to off, such as the first switch 340 and the second switch 342 as well as the fire control switch 346. At block 522, the system can set hardware delays (such as forty-five ms) on one or more of the switches in case there is an ESAD microcontroller pin pulse during bootup. See the delay circuit 343 in FIG. 3C as an example. At block 524, the ECAD and firing circuit board 336 monitors sensors such as an accelerometer and pressure sensor for a set of parameters that would indicate a launch. The set of parameters in one example can include an acceleration threshold (such as, for example, 1.26 g's for 0.5 seconds), a flight time threshold (such as, for example, ten seconds) and/or an altitude threshold (such as, for example, thirty meters). At block 526, voltages are set as follows: EIN=24V; EOUT=0V; FOUT=0V; IIN=0V and FOUT !=IIN. At block 528, because the pull-after-launch safety pin 332 is still installed, IIN is still electrically separated from the rest of the circuity and IIN !=FOUT.

FIG. 5B illustrates a launch and eventual detonation series 530 for the ground-launched air-to-air munition (G-LAAM), in accordance with some example implementations. At block 532, the voltages are set as follows: EIN=24V; EOUT=0V; FOUT=0V; IIN=0V and FOUT !=IIN. At block 534, a server or a human can operate the intercept aircraft 108 such that the G-LAAM is at a safe distance from people or property that could be damaged upon launch. At block 536, the intercept aircraft 108 launches and at block 538, the intercept aircraft 108 reaches a certain threshold height, such as, for example, two meters off the ground. At block 540, the cable 204 or safety pull cord attached to the weighted base 352 is pulled which pulls out the pull-after-launch safety pin 332. The after-launch safety switch 334 closes and an electrical connection between the firing control circuit 344 and the initiator is obtained.

At block 542, the initiator is electrically connected to the firing circuit output such that FOUT=IIN. At block 544, the voltage settings are EIN=24V; EOUT=0V; FOUT=IIN=0V. Again, FIG. 3C illustrates the location of each of these voltages in the ESAD and firing circuit board 336. At block 546, the ESAD and firing circuit board 336 determines whether the three thresholds are met including an acceleration threshold, a flight time threshold and an altitude threshold and at block 548, the ESAD and firing circuit board 336 send signals to close one or more of the first switch 340 and the second switch 342. Note in block 548 that MOSFETS Q4 and Q1 are referenced. These MOSFETS are shown in FIG. 3C. At block 550, the system provides a hardware delay such as, for example, forty-five ms (implemented by way of example with delay circuit 343 shown in FIG. 3C) and at block 552, the first switch 340, the second switch 342 close, placing power to the firing control circuit 344. At block 554, the voltages are: EIN=24V; EOUT=24V; FOUT=IIN=0V. At block 556, the intercept aircraft 108 is guided to the target aircraft 110 and at block 558, a firing command is sent from the vehicle onboard computer (i.e., a control system on the intercept aircraft 108) and received at the firing control circuit 244. The firing command is sent when the intercept aircraft 108 is at the proper intercept point 132, in an armed state, and ready to fire. At block 560, the firing control circuit 344 sends a signal to the fire control switch 346. Note that the figure references two MOSFETs in connection with the firing control. FIG. 3B shows a single switch or MOSFET as the fire control switch 346. There may be two switches or MOSFETS Q5 and Q2 that are used in connection with block 560 as shown in FIG. 3C. At block 564, the firing control switch 346 (and any other associated switches) close and at block 564, the voltages are: EIN=24V; EOUT=24V; FOUT=IIN=24V. At block 566, the initiator functions and at block 568, the main charge detonates.

Note that a timeline between when a battery is installed on an intercept aircraft 108 and when a main charge explodes can include periods that have variable amounts of time and other periods that are fixed. For example, the timeline can include a first variable amount of time from after the battery is installed to when the intercept aircraft 108 is launched. A launch, the intercept aircraft 108 receives launch command and begins accent. When the battery is installed, power is provided to the EDAS and filing circuit board 336 as well as the input of the EDAS. The intercept aircraft 108 remains in this state until a receives a launch command. A fixed amount of time at which the intercept aircraft 108 is accelerating at 1.25 g's is tracked, such as for 0.5 seconds. Then a fixed amount of time of flight, such as ten seconds is tracked from the 1.25 g event.

There may be a second variable amount of time to when a certain threshold altitude is met. Then, from a time of when a set of safety environment thresholds are met, a command can be generated to close one or more switches and a preset delay of, for example, forty-five ms is implemented before the switches close. Then a third variable period of time is implemented until a vehicle on-board computer sends a detonation command to the firing control circuit 344. In less than one ms, the firing control circuit 344 causes the fire control switch 346 to close and the initiator in less than one ms starts to function to detonate the main charge.

FIG. 6 shows an example of computing system 600. The computing system 600 can be a controller or one of the one or more processors 604. The computing system 600 can perform the functions of the aircraft environment 100 or of the intercept aircraft 108. The computing system 600 can be part of a distributed computing network in which several computers perform respective steps in method 400. The computing system 600 can be connected to the other parts of the distributed computing network via connection 602 or communication interface 624. Connection 602 can be a physical connection via a bus, or a direct connection into one or more processors 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) or one or more processors 604 and connection 602 that couples various system components including system memory 608, such as read-only memory (ROM) 610 and random access memory (RAM) 612 to processor or one or more processors 604. Computing system 600 can include a cache of high-speed memory 606 connected directly with, in close proximity to, or integrated as part of processor or one or more processors 604. One or more processors 604 may essentially be a completely self-contained computing system, containing multiple cores or processors, a bus, memory controller, cache, etc. A multi-core processor may be symmetric or asymmetric.

One or more processors 604 can include any general-purpose processor and a hardware service or software service, such as services 616, 618, and 620 stored in storage device 614, configured to control the one or more processors 604 as well as a special-purpose processor where software instructions are incorporated into the actual processor design.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include a communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the one or more processors 604, it causes the system to perform a function. In some implementations, a hardware service that performs a particular function can include the software component stored in a computer-readable medium in connection with the necessary hardware components, such processor or one or more processors 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some implementations, a service can be software that resides in the memory of the intercept aircraft 108 or of the one or more processors 604 and performs one or more functions of method 400 when a processor executes the software associated with the service. In some implementations, a service is a program or a collection of programs that carry out a specific function. In some implementations, a service can be considered a server. The memory can be a non-transitory computer-readable medium.

In some implementations, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data that cause or otherwise configure a general-purpose computer, special-purpose computer, or special-purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

It is noted that in one aspect, a computer or computers can be deployed upon a flying machine, such as a drone, or as part of a projectile module that is removably attached to a drone in which interfaces with the control system of the drone. The computer or computer devices may also be deployed as a separate control system which can communicate with a drone and/or a projectile module and/or projectile itself. Any wireless protocol is contemplated as being utilized for such communication.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some implementations, a service can be software that resides in memory of a client device and/or one or more servers of a content management system and perform one or more functions when a processor executes the software associated with the service. In some implementations, a service is a program, or a collection of programs that carry out a specific function. In some implementations, a service can be considered a server. The memory can be a non-transitory computer-readable medium.

In some implementations, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The following are various claim clauses according to this disclosure:

Clause 1. A flying machine comprising: an explosive device fixed to a body of the flying machine; an arming device configured to interrupt a detonation path when in a safe state and to complete the detonation path when in an armed state; one or more sensors configured to measure an acceleration, a position, and/or an environmental condition of the flying machine and to generate sensor data therefrom; one or more processors; and a memory storing instructions that, when executed by the one or more processors, configure the flying machine to: determine, based on the sensor data, whether two or more arming criteria are satisfied, and signal the arming device to transition from the safe state to the armed state when the two or more arming criteria are satisfied.

Clause 2. The flying machine of clause 1, further comprising: a tethered device comprising an engagement member that is tethered via a cable to a platform or weighted base, wherein a length of the cable exceeding a predefined length, such that when the flying machine is separated from the platform or weighted base by more than the length of the cable the engagement member disengages from the flying machine, while the engagement member is engaged with the flying machine, the tethered device prevents arming the explosive device, and when the engagement member is disengaged from the flying machine, the tethered device ceases to prevent arming the explosive device.

Clause 3. The flying machine of clause 1 or any previous clause, wherein the one or more sensors comprise an inertial measurement unit (IMU) comprising an accelerometer, a gyroscope, and/or a magnetometer to measure inertial navigation data, and the sensor data comprises the inertial navigation data.

Clause 4. The flying machine of clause 3 or any previous clause, wherein the IMU comprises a three-axis accelerometer or three one-axis accelerometers, a three-axis gyroscope or three one-axis gyroscopes, and a three-axis magnetometer or three one-axis magnetometers.

Clause 5. The flying machine of clause 1 or any previous clause, wherein the arming device comprises a relay that causes an open circuit when in the safe state and the relay causes a closed circuit when in the armed state, such that a detonation signal can pass through the relay to a detonator of the explosive device.

Clause 6. The flying machine of clause 1 or any previous clause, further comprising: a radar configured to emit electromagnetic radiation, detect return electromagnetic radiation that is reflected from a second flying machine, and generate radar data based on the return electromagnetic radiation, wherein the stored instructions, when executed by the one or more processors, further configure the flying machine to perform functions of a proximity fuse of the explosive device by determining a distance between the flying machine and a target, and, when the distance is within a predefined range of distances, detonating the explosive device.

Clause 7. The flying machine of clause 1 or any previous clause, wherein the two or more arming criteria include: a first determination that the flying machine has undergone the acceleration exceeding an acceleration threshold for a predefined time period; a second determination, based on barometer data which is included in the sensor data, that the flying machine has reached a predefined altitude relative to a launch altitude; a predefined change in barometer values of the barometer data; and/or a third determination, based on magnetometer data which is included in the sensor data, that the flying machine has reached the predefined altitude relative to the launch altitude.

Clause 8. The flying machine of clause 1 or any previous clause, wherein: the two or more arming criteria include a determination that the flying machine has undergone a predefined pattern of accelerations and changes in altitude that indicate the flying machine has executed one or more acrobatic maneuvers; and the one or more acrobatic maneuvers includes: a predefined sequence of one or more barrel roles, a predefined sequence of one or more S-curves, a predefined sequence of one or more loops, a predefined sequence of one or more rolls, a predefined sequence of one or more FIG. 8's, a predefined sequence of one or more spins, a predefined sequence of one or more hammerhead stall turns, or a combination thereof.

Clause 9. The flying machine of clause 1 or any previous clause, wherein: the two or more arming criteria include a determination that the flying machine has undergone a predefined pattern of accelerations and changes in altitude that indicate the flying machine has executed one or more acrobatic maneuvers; and the predefined pattern of the accelerations is selected to have a probability of accidentally occurring that is less than a predefined threshold.

Clause 10. The flying machine of clause 1 or any previous clause, wherein the two or more arming criteria are selected such that a probability of a combination of the two or more arming criteria accidentally occurring is less than a predefined threshold.

Clause 11. The flying machine of clause 1 or any previous clause, wherein the stored instructions, when executed by the one or more processors, further configure the flying machine to switch the explosive device from the armed state to the safe state, when one or more safe criteria have been satisfied.

Clause 12. The flying machine of clause 11 or any previous clause, wherein the one or more safe criteria comprise: that a power reserve of the flying machine has fallen below a predefined level, the flying machine has entered a space where detonation of the explosive device is not permitted, the flying machine is returning to a launch location, or the flying machine receives a communication with an instruction to be in the safe state.

Clause 13. The flying machine of clause 1 or any previous clause, wherein the explosive device is detachable from the body of the flying machine and the explosive device includes a communication port for communicating between the explosive device and at least one processor of the one or more processors and wherein the weighted base is attachable to the flying machine and removable via a remove-before-flight safety pin.

Clause 14. The flying machine of clause 13 or any previous clause, wherein the explosive device snaps onto the flying machine, and, after snapping onto the flying machine, the explosive device is secured at two or more points via fasteners extending through the explosive device into a fuselage/body of the flying machine.

Clause 15. The flying machine of clause 13 or any previous clause, wherein the communication port is a wired port that electrically connects the explosive device to the flying machine when the explosive device is fixed to the flying machine.

Clause 16. The flying machine of clause 15 or any previous clause, wherein the communication port is a parallel port, a serial port, a DIN port, an RS-232C, an RS-422A, an RS-485, DE-9 port, a DB-25 port, a USB port, an ethernet port, a ruggedized port, or a firewire port.

Clause 17. The flying machine of clause 15 or any previous clause, wherein the communication port provides electrical power from the flying machine to the explosive device.

Clause 18. The flying machine of clause 13 or any previous clause, wherein the flying machine has an electrical power supply, and the explosive device has another electrical power supply that is separate from the electrical power supply of the flying machine.

Clause 19. The flying machine of clause 13 or any previous clause, wherein the communication port is a wireless port.

Clause 20. The flying machine of clause 19 or any previous clause, wherein the communication port is a BLUETOOTH communication port, a BLUETOOTH LE communication port, a NEAR FIELD communication port, a ZIGBEE communication port, a Z-WAVE communication port, a 6LoWPAN communication port, a WIFI communication port, a 3G communication port, a 4G communication port, a 5G communication port, an LTE communication port, a secure communication port, or an encrypted communication port.

Clause 21. A method of arming an explosive device of an aircraft, the method comprising: generating sensor data using one or more sensors configured to measure an acceleration, a position, and/or an environmental condition of a flying machine; processing, by one or more processors, the sensor data to determine whether two or more arming criteria are satisfied; signaling, to an arming device, an instruction to transition from a safe state to an armed state when the two or more arming criteria are determined to be satisfied; and transitioning from the safe state to the armed state by completing a detonation path through the arming device to thereby allow a detonation signal to pass through the arming device towards the explosive device of the flying machine.

Clause 22. The method of clause 21, further comprising: tethering an engagement member to a platform or weighted base via a cable, wherein a length of the cable exceeds a predefined distance within which an explosion is not permitted, such that, when the flying machine is separated from the platform or weighted base by more than the length of the cable, the cable disengages from the engagement member, while the engagement member is engaged with the cable, the engagement member prevents detonating the explosive device, and when the engagement member is disengaged from the cable, the engagement member ceases to prevent detonating the explosive device.

Clause 23. The method of clause 21 or any previous method clause, wherein the one or more sensors comprise an inertial measurement unit (IMU) comprising an accelerometer, a gyroscope, and/or a magnetometer to measure inertial navigation data, and the sensor data comprises the inertial navigation data.

Clause 24. The method of clause 23 or any previous method clause, wherein the IMU comprises a three-axis accelerometer or three one-axis accelerometers, a three-axis gyroscope or three one-axis gyroscopes, and a three-axis magnetometer or three one-axis magnetometers.

Clause 25. The method of clause 21 or any previous method clause, wherein the arming device comprises a relay that causes an open circuit when in the safe state and the relay causes a closed circuit when in the armed state, such that the detonation signal can pass through the relay to a detonator of the explosive device.

Clause 26. The method of clause 21 or any previous method clause, further comprising: generating radar data based on return electromagnetic radiation that is detected by a radar that is configured to emit electromagnetic radiation and detect the return electromagnetic radiation that is reflected from a target; and processing, at the one or more processors, the radar data for proximity fusing by determining a distance between the flying machine and the target, and, when the distance is within a predefined range of distances, detonating the explosive device.

Clause 27. The method of clause 21 or any previous method clause, wherein the two or more arming criteria include: a first determination that the flying machine has undergone the acceleration exceeding an acceleration threshold for a predefined time period; a second determination, based on barometer data which is included in the sensor data, that the flying machine has reached a predefined altitude relative to a launch altitude; a predefined change in barometer values of the barometer data; and/or a third determination, based on magnetometer data which is included in the sensor data, that the flying machine has reached the predefined altitude relative to the launch altitude.

Clause 28. The method of clause 21 or any previous method clause, wherein: the two or more arming criteria include a determination that the flying machine has undergone a predefined pattern of accelerations and changes in altitude that indicate the flying machine has executed one or more acrobatic maneuvers, wherein the one or more acrobatic maneuvers includes: a predefined sequence of one or more barrel roles, a predefined sequence of one or more S-curves, a predefined sequence of one or more loops, a predefined sequence of one or more rolls, a predefined sequence of one or more FIG. 8's, a predefined sequence of one or more spins, a predefined sequence of one or more hammerhead stall turns, or a combination thereof.

Clause 29. The method of clause 21 or any previous method clause, wherein: the two or more arming criteria include a determination that the flying machine has undergone a predefined pattern of accelerations and changes in altitude that indicate the flying machine has executed one or more acrobatic maneuvers, wherein the predefined pattern of the accelerations is selected to have a probability of accidentally occurring that is less than a predefined threshold.

Clause 30. The method of clause 21 or any previous method clause, wherein the two or more arming criteria are selected such that a probability of a combination of the two or more arming criteria accidentally occurring is less than a predefined threshold.

Clause 31. The method of clause 21 or any previous method clause, further comprising: causing the explosive device to be in a save state by switching the arming device from the armed state to the safe state, when one or more safe criteria have been satisfied.

Clause 32. The method of clause 31 or any previous method clause, wherein the one or more safe criteria comprise: that a power reserve of the flying machine has fallen below a predefined level, the flying machine has entered a space where detonation of the explosive device is not permitted, the flying machine is returning to a launch location, or the flying machine receives a communication with an instruction to switch to the safe state.

Clause 33. An explosive device that is configured to attach to a flying machine, the explosive device comprising: an explosive; a detonation device configured to detonate the explosive; a detonation signal system between the detonation device and a detonation source, the detonation signal system comprising a detonation signal path and an arming device, wherein the detonation signal path is configured to conduct a detonation signal from the detonation source to the detonation device, and the arming device is configured to prevent detonating an explosive when in a safe state and allow detonating the explosive when in an armed state; one or more processors; and a memory storing instructions that, when executed by the one or more processors, configure the explosive device to: determine, based on sensor data of an inertial measurement unit (IMU), whether two or more arming criteria are satisfied, and signal the arming device to transition from the safe state to the armed state when the two or more arming criteria are satisfied.

Clause 34. The explosive device of clause 33, wherein, when in the safe state, the arming device prevents the detonation device from detonating in response to having received the detonation signal and/or interrupts the detonation signal path from transmitting the detonation signal to the detonation device.

Clause 35. The explosive device of clause 33 or any previous device clause, wherein the explosive device can be configured to attach to the flying machine that is a vertical-take-off-and-landing flying machine and wherein the explosive device comprises blast characteristics of the explosive and is configured to attach to the flying machine, wherein the blast characteristics cause the flying machine to position itself, based on the blast characteristics, relative to a target aircraft.

Clause 36. The explosive device of clause 33, further comprising: an engagement member that is configured to engage an end of a cable and configured to disengage from the cable when more than a predefined amount of force is applied between the cable and the engagement member, wherein while the engagement member is engaged with the cable, the engagement member prevents the explosive device from detonating, and when the engagement member is disengaged from the flying machine, the engagement member ceases to prevent the explosive device from detonating.

Clause 37. The explosive device of clause 33 or any previous device clause, wherein the IMU comprises an accelerometer, a gyroscope, and/or a magnetometer to measure inertial navigation data, and the sensor data comprises the inertial navigation data.

Clause 38. The explosive device of clause 33 or any previous device clause, wherein the IMU comprises a three-axis accelerometer or three one-axis accelerometers, a three-axis gyroscope or three one-axis gyroscopes, and a three-axis magnetometer or three one-axis magnetometers.

Clause 39. The explosive device of clause 33 or any previous device clause, wherein the arming device comprises a relay that causes an open circuit when in the safe state and the relay causes a closed circuit when in the armed state, such that a detonation signal can pass through the relay to a detonator of the explosive device.

Clause 40. The explosive device of clause 33 or any previous device clause, further comprising: a radar configured to emit electromagnetic radiation, detect return electromagnetic radiation that is reflected from a second flying machine, and generate radar data based on the return electromagnetic radiation, wherein the stored instructions, when executed by the one or more processors, further configure the flying machine to perform functions of a proximity fuse of the explosive device by determining a distance between the explosive device and a target, and, when the distance is within a predefined range of distances, detonating the explosive device.

Clause 41. The explosive device of clause 33 or any previous device clause, wherein the two or more arming criteria include: a first determination that the flying machine has undergone the acceleration exceeding an acceleration threshold for a predefined time period; a second determination, based on barometer data which is included in the sensor data, that the flying machine has reached a predefined altitude relative to a launch altitude; a predefined change in barometer values of the barometer data; and/or a third determination, based on magnetometer data which is included in the sensor data, that the flying machine has reached the predefined altitude relative to the launch altitude.

Clause 42. The explosive device of clause 33 or any previous device clause, wherein: the two or more arming criteria include a determination that the flying machine has undergone a predefined pattern of accelerations and changes in altitude that indicate the flying machine has executed one or more acrobatic maneuvers, wherein the one or more acrobatic maneuvers includes: a predefined sequence of one or more barrel roles, a predefined sequence of one or more S-curves, a predefined sequence of one or more loops, a predefined sequence of one or more rolls, a predefined sequence of one or more FIG. 8's, a predefined sequence of one or more spins, a predefined sequence of one or more hammerhead stall turns, or a combination thereof.

Clause 43. The explosive device of clause 33 or any previous device clause, wherein: the two or more arming criteria include a determination that the flying machine has undergone a predefined pattern of accelerations and changes in altitude that indicate the flying machine has executed one or more acrobatic maneuvers, wherein the predefined pattern of the accelerations is selected to have a probability of accidentally occurring that is less than a predefined threshold.

Clause 44. The explosive device of clause 33 or any previous device clause, wherein the two or more arming criteria are selected such that a probability of a combination of the two or more arming criteria accidentally occurring is less than a predefined threshold.

Clause 45. The explosive device of clause 33 or any previous device clause, wherein the stored instructions, when executed by the one or more processors, further configure the flying machine to switch the explosive device from the armed state to the safe state, when one or more safe criteria have been satisfied.

Clause 46. The explosive device of clause 45 or any previous device clause, wherein the one or more safe criteria comprise: that a power reserve of the flying machine has fallen below a predefined level, the flying machine has entered a space where detonating the explosive device is not permitted, the flying machine is returning to a launch location, or the flying machine receives a communication with an instruction to be in the safe state.

Clause 47. The explosive device of clause 33 or any previous device clause, further comprising: a detachable housing that is configured to be detachably fixed to a body of the flying machine; and a communication port for communicating between the explosive device and at least one processor of the one or more processors that is not part of the explosive device.

Clause 48. The explosive device of clause 47 or any previous device clause, wherein the detachable housing snaps onto the flying machine, and, after snapping onto the flying machine, the explosive device is secured at two or more points via fasteners extending through the explosive device into the body of the flying machine.

Clause 49. The explosive device of clause 47 or any previous device clause, wherein the communication port is a wired port that electrically connects the explosive device to the flying machine when the explosive device is fixed to the flying machine.

Clause 50. The explosive device of clause 49 or any previous device clause, wherein the communication port is a parallel port, a serial port, a DIN port, an RS-232C, an RS-422A, an RS-485, DE-9 port, a DB-25 port, a USB port, an ethernet port, a ruggedized port, or a firewire port.

Clause 51. The explosive device of clause 49 or any previous device clause, wherein the communication port provides electrical power from the flying machine to the explosive device.

Clause 52. The explosive device of clause 47 or any previous device clause, wherein the explosive device has a separate electrical power supply from an electrical power supply of the flying machine.

Clause 53. The explosive device of clause 47 or any previous device clause, wherein the communication port is a wireless port.

Clause 54. The explosive device of clause 53 or any previous device clause, wherein the communication port is a BLUETOOTH communication port, a BLUETOOTH LE communication port, a NEAR FIELD communication port, a ZIGBEE communication port, a Z-WAVE communication port, a 6LoWPAN communication port, a WIFI communication port, a 3G communication port, a 4G communication port, a 5G communication port, an LTE communication port, a secure communication port, or an encrypted communication port.

Clause 55. A method of operating an explosive device that is configured to attach to a flying machine, the explosive device comprising an explosive; a detonation device configured to detonate the explosive; a detonation signal system between the detonation device and a detonation source, the detonation signal system comprising a detonation signal path and an arming device, wherein the detonation signal path is configured to conduct a detonation signal from the detonation source to the detonation device, and the arming device is configured to prevent detonating an explosive when in a safe state and allow detonating the explosive when in an armed state, the method comprising: determining, based on sensor data of an inertial measurement unit (IMU), whether two or more arming criteria are satisfied, and signaling the arming device to transition from the safe state to the armed state when the two or more arming criteria are satisfied.

Clause 56. A computer-readable storage media storing instructions which, when executed by one or more processors, cause the one or more processors to be configured to: determine, based on sensor data of an inertial measurement unit (IMU), whether two or more arming criteria are satisfied for an explosive device, the explosive device comprising: an explosive; a detonation device configured to detonate the explosive; a detonation signal system between the detonation device and a detonation source, the detonation signal system comprising a detonation signal path and an arming device, wherein the detonation signal path is configured to conduct a detonation signal from the detonation source to the detonation device, and the arming device is configured to prevent detonating an explosive when in a safe state and allow detonating the explosive when in an armed state; and signal the arming device to transition from the safe state to the armed state when the two or more arming criteria are satisfied.

Clause 57. A computer-readable storage media storing instructions which, when executed by one or more processors configured on a flying machine comprising an explosive device fixed to a body of the flying machine; an arming device configured to prevent detonating an explosive when in a safe state and allow detonating the explosive when in an armed state; one or more sensors configured to measure an acceleration, a position, and/or an environmental condition of the flying machine and to generate sensor data therefrom, cause the one or more processors to be configured to: determine, based on the sensor data, whether two or more arming criteria are satisfied, and signal the arming device to transition from the safe state to the armed state when the two or more arming criteria are satisfied.

Clause 58. A flying machine comprising: an explosive device that is attachable to a body of the flying machine, the explosive device comprising a memory that stores blast characteristics of an explosive on the explosive device; an arming device configured to prevent detonating an explosive when in a safe state and allow detonating the explosive when in an armed state; one or more sensors configured to measure an acceleration, a position, and/or an environmental condition of the flying machine and to generate sensor data therefrom; one or more processors; and a memory storing instructions that, when executed by the one or more processors, configure the flying machine to: receive the blast characteristics of the explosive from the explosive device; position the flying machine at an intercept position relative to a target aircraft based on the blast characteristics of the explosive; determine, based on the sensor data, whether two or more arming criteria are satisfied, signal the arming device to transition from the safe state to the armed state when the two or more arming criteria are satisfied; and detonate the explosive, while in the armed state, when the flying machine is at the intercept position relative to the target aircraft.

Clause 59. A method of operating an intercept aircraft the method comprising: receiving an explosive device on the intercept aircraft; receiving blast characteristics of an explosive on the explosive device from a memory of the explosive device; moving, based on the blast characteristics, the intercept aircraft to an intercept position relative to a target aircraft; and detonating the explosive on the explosive device when the intercept aircraft reaches the intercept position relative to the target aircraft.

Clause 60. A flying machine comprising one or more of: an explosive device fixed to a body of the flying machine; an arming device configured to prevent detonating an explosive when in a safe state and allow detonating the explosive when in an armed state; one or more sensors configured to measure an acceleration, a position, and/or an environmental condition of the flying machine and to generate sensor data therefrom; an after-launch safety pin connected to an after-launch safety switch; a weighted base held in an attached position to the flying machine by a remove-before flight safety pin, wherein, upon removal of the remove-before flight safety pin, the weighted base is no longer in the attached position and only remains connected to the flying machine by a tether or cable attached to the after-launch safety pin and wherein after the flying machine launches and reaches a length of the tether or cable, the tether or cable causes the after-launch safety pin to be pulled to close the after-launch safety switch; one or more processors; and a memory storing instructions that, when executed by the one or more processors, configure the flying machine to: determine, based on the sensor data, whether two or more arming criteria are satisfied, and signal the arming device to transition from the safe state to the armed state when the two or more arming criteria are satisfied and when the after-launch safety switch is closed.

Clause 61. A flying machine comprising one or more of: an explosive device attached to a body of the flying machine, the explosive device comprising a memory storing blast characteristics of an explosive; an arming device configured to prevent detonating an explosive when in a safe state and allow detonating the explosive when in an armed state; one or more processors; and a memory storing instructions that, when executed by the one or more processors, configure the flying machine to: receive the blast characteristics of the explosive; select an arming mode from a plurality of arming modes based on the blast characteristics, the arming mode implemented by the arming device; and control the flying machine to fly to an intercept position and detonate the explosive based on the arming mode.

Clause 62. The flying machine of clause 61, further comprising: one or more sensors configured to measure an acceleration, a position, and/or an environmental condition of the flying machine and to generate sensor data therefrom; an after-launch safety pin connected to an after-launch safety switch; a weighted base held in an attached position to the flying machine by a remove-before flight safety pin, wherein, upon removal of the remove-before flight safety pin, the weighted base is no longer in the attached position and only remains connected to the flying machine by a tether or cable attached to the after-launch safety pin and wherein after the flying machine launches and reaches a length of the tether or cable, the tether causes the after-launch safety pin to be pulled to close the after-launch safety switch.

Clause 63. The flying machine of clause 62, wherein the one or more processors are configured to determine, based on the sensor data, whether two or more arming criteria are satisfied, and signal the arming device to transition from the safe state to the armed state when the two or more arming criteria are satisfied and when the after-launch safety switch is closed.

What is claimed is:

1. A flying machine comprising:
an explosive device fixed to a body of the flying machine;
an arming device configured to prevent detonating an explosive in the explosive device when in a safe state and allow detonating the explosive when in an armed state;
one or more sensors configured to measure an acceleration, a position, and/or an environmental condition of the flying machine and to generate sensor data therefrom;
one or more processors; and
a memory storing instructions that, when executed by the one or more processors, configure the flying machine to:
determine, based on the sensor data, whether two or more arming criteria are satisfied, and
signal the arming device to transition from the safe state to the armed state when the two or more arming criteria are satisfied.

2. The flying machine of claim 1, further comprising:
a tethered device comprising an engagement member that is tethered via a cable to a platform or a weighted base, wherein:
a length of the cable exceeding a predefined length, such that when the flying machine is separated from the platform or the weighted base by more than the length of the cable the engagement member disengages from the flying machine,
while the engagement member is engaged with the flying machine, the tethered device prevents arming the explosive device, and
when the engagement member is disengaged from the flying machine, the tethered device ceases to prevent arming the explosive device.

3. The flying machine of claim 1, wherein the one or more sensors comprise an inertial measurement unit (IMU) comprising an accelerometer, a gyroscope, and/or a magnetometer to measure inertial navigation data, and the sensor data comprises the inertial navigation data.

4. The flying machine of claim 1, wherein the arming device comprises a relay that causes an open circuit when in the safe state and the relay causes a closed circuit when in the armed state, such that a detonation signal can pass through the relay to a detonator of the explosive device.

5. The flying machine of claim 1, further comprising:
a radar configured to emit electromagnetic radiation, detect return electromagnetic radiation that is reflected from a second flying machine, and generate radar data based on the return electromagnetic radiation, wherein the stored instructions, when executed by the one or more processors, further configure the flying machine to perform functions of a proximity fuse of the explosive device by determining a distance between the flying machine and a target, and, when the distance is within a predefined range of distances, detonating the explosive device.

6. The flying machine of claim 1, wherein the two or more arming criteria include:
a first determination that the flying machine has undergone the acceleration exceeding an acceleration threshold for a predefined time period;
a second determination, based on barometer data which is included in the sensor data, that the flying machine has reached a predefined altitude relative to a launch altitude;
a predefined change in barometer values of the barometer data; and/or
a third determination, based on magnetometer data which is included in the sensor data, that the flying machine has reached the predefined altitude relative to the launch altitude.

7. The flying machine of claim 1, wherein:
the two or more arming criteria include a determination that the flying machine has undergone a predefined pattern of accelerations and changes in altitude that indicate the flying machine has executed one or more acrobatic maneuvers; and
the one or more acrobatic maneuvers comprises: a predefined sequence of one or more barrel roles, a predefined sequence of one or more S-curves, a predefined sequence of one or more loops, a predefined sequence of one or more rolls, a predefined sequence of one or more FIG. 8's, a predefined sequence of one or more spins, a predefined sequence of one or more hammerhead stall turns, or a combination thereof.

8. The flying machine of claim 1, wherein the two or more arming criteria are selected such that a probability of a combination of the two or more arming criteria accidentally occurring is less than a predefined threshold.

9. The flying machine of claim 1, wherein the stored instructions, when executed by the one or more processors, further configure the flying machine to switch the explosive device from the armed state to the safe state, when one or more safe criteria have been satisfied.

10. The flying machine of claim 1, wherein the explosive device is detachable from the body of the flying machine and the explosive device includes a communication port for communicating between the explosive device and at least one processor of the one or more processors and wherein the weighted base is attachable to the flying machine and removable via a remove-before-flight safety pin.

11. A method of arming an explosive device of an aircraft, the method comprising:
generating sensor data using one or more sensors configured to measure an acceleration, a position, and/or an environmental condition of a flying machine;
processing, by one or more processors, the sensor data to determine whether two or more arming criteria are satisfied;
preventing the explosive device from detonating when in a safe state;
signaling, to an arming device, an instruction to transition from the safe state to an armed state when the two or more arming criteria are determined to be satisfied; and
transitioning from the safe state to the armed state by passing a detonation signal to along a detonation path to a detonation device and allowing the detonation device to detonate in response to the detonation signal through the arming device to detonate the explosive device of the flying machine.

12. The method of claim 11, further comprising:
tethering an engagement member to a platform or a weighted base via a cable, wherein a length of the cable exceeds a predefined distance within which an explosion is not permitted, such that, when the flying machine is separated from the platform or weighted base by more than the length of the cable, the cable disengages from the engagement member,
while the engagement member is engaged with the cable, the engagement member prevents detonating the explosive device, and
when the engagement member is disengaged from the cable, the engagement member ceases to prevent detonating the explosive device.

13. The method of claim 11, wherein the one or more sensors comprise an inertial measurement unit (IMU) comprising an accelerometer, a gyroscope, and/or a magnetometer to measure inertial navigation data, and the sensor data comprises the inertial navigation data.

14. The method of claim 11, wherein the arming device comprises a relay that causes an open circuit when in the safe state and the relay causes a closed circuit when in the armed state, such that the detonation signal can pass through the relay to a detonator of the explosive device.

15. The method of claim 11, wherein the two or more arming criteria include:
a first determination that the flying machine has undergone the acceleration exceeding an acceleration threshold for a predefined time period;
a second determination, based on barometer data which is included in the sensor data, that the flying machine has reached a predefined altitude relative to a launch altitude;
a predefined change in barometer values of the barometer data; and/or
a third determination, based on magnetometer data which is included in the sensor data, that the flying machine has reached the predefined altitude relative to the launch altitude.

16. The method of claim 11, wherein:
the two or more arming criteria include a determination that the flying machine has undergone a predefined pattern of accelerations and changes in altitude that indicate the flying machine has executed one or more acrobatic maneuvers; and
the one or more acrobatic maneuvers includes: a predefined sequence of one or more barrel roles, a predefined sequence of one or more S-curves, a predefined sequence of one or more loops, a predefined sequence of one or more rolls, a predefined sequence of one or more FIG. 8's, a predefined sequence of one or more spins, a predefined sequence of one or more hammerhead stall turns, or combination thereof.

17. The method of claim 11, further comprising:
causing the explosive device to be in a safe state by switching the arming device from the armed state to the safe state, when one or more safe criteria have been satisfied, wherein the one or more safe criteria comprise: that a power reserve of the flying machine has fallen below a predefined level, the flying machine has entered a space where detonation of the explosive device is not permitted, the flying machine is returning to a launch location, or the flying machine receives a communication with an instruction to switch to the safe state.

18. An explosive device that is configured to attach to a flying machine, the explosive device comprising:
an explosive;
a detonation device configured to detonate the explosive;
a detonation signal system between the detonation device and a detonation source, the detonation signal system comprising a detonation signal path and an arming device, wherein:
the detonation signal path is configured to conduct a detonation signal from the detonation source to the detonation device, and
the arming device is configured to prevent detonating an explosive when in a safe state and allow detonating the explosive when in an armed state;
one or more processors; and
a memory storing instructions that, when executed by the one or more processors, configure the explosive device to:
determine, based on sensor data of an inertial measurement unit (IMU), whether two or more arming criteria are satisfied, and
signal the arming device to transition from the safe state to the armed state when the two or more arming criteria are satisfied.

19. The explosive device of claim 18, wherein, when in the safe state, the arming device prevents the detonation device from detonating in response to having received the detonation signal and/or interrupts the detonation signal path from transmitting the detonation signal to the detonation device.

20. The explosive device of claim 18, wherein the explosive device comprises blast characteristics of the explosive and is configured to attach to the flying machine, wherein the blast characteristics cause the flying machine to position itself, based on the blast characteristics, relative to a target aircraft.
